(19) United States
(12) Patent Application Publication
(10) Pub. No.: US 2018/0247277 A1
(43) Pub. Date: Aug. 30, 2018

(54) Verified Motor Vehicle Repair Process and System

(71) Applicant: Craig Alan Livernois, Chesapeake, VA (US)

(72) Inventor: Craig Alan Livernois, Chesapeake, VA (US)

(21) Appl. No.: 15/441,254

(22) Filed: Feb. 24, 2017

(51) Int. Cl. G06Q 10/00; G07C 5/08; G06Q 30/00

(52) U.S. Cl. CPC G06Q 10/20; G06Q 30/018; G07C 5/0808

(57) ABSTRACT

A nine step process for verifying a motor vehicle repair including: obtaining a problem description from a vehicle operator; verifying the problem, diagnosing the problem, verifying the diagnosis, dealing with an unverifiable problem, estimating a repair cost, performing a repair, verifying the repair is properly performed, verifying that the repair has fixed the problem. At least one repair technician and at least one check technician work together to verify the diagnosis and repair. If a repair does not fix the problem, a prescribed process is used to redo the repair. An electronic job ticket is used to track and time stamp each step of the process and track all parts and materials used in the repair process. All data is stored in a database that may be queried to obtain management reports required by a motor vehicle repair business.

### FIELD OF THE INVENTION

The invention pertains to methods of verifying repairs and, more particularly, to integrated methods of performing and verifying repairs of motor vehicles.

### BACKGROUND OF THE INVENTION

Few areas of commercial enterprise result in more consumer complaints than the repair of motor vehicles. Complaints run the gamut from outright rip-offs (e.g., work and/or a part were sold but not performed or delivered) to shoddy workmanship, damage to a vehicle while a repair is being performed, and errors made by untrained, undertrained, or improperly supervised service technicians (e.g., mechanics or repair personnel).

A visit to a vehicle repair facility causes anxiety to many vehicle owners. Consequently, some vehicle owners may postpone vehicle repairs until absolutely necessary.

It would, therefore, be advantageous to provide a systemized method for ensuring that vehicle problems are properly diagnosed, properly repaired, and properly invoiced.

### Discussion of the Related Art

Several attempts to provide improved methods of motor vehicle repair may be found in the prior art. For example, U.S. Pat. No. 8,996,235 for REPAIR ASSIST SYSTEM FOR VEHICLE SERVICING, issued Mar. 31, 2015 to Satnam Singh et al., shows service procedures wherein steps to preclude inappropriate repairs are undertaken (column 1, lines 49-53). The procedures include test driving by a technician (column 2, lines 50-61) and checking history of previously encountered trouble codes (column 3, lines 15-40).

U.S. Pat. No. 7,069,333 for METHOD AND SYSTEM FOR WIRELESS COMMUNICATION FOR A FIELD SERVICE SYSTEM, issued Jun. 27, 2006 to Roy Morris et al., further details consulting the historical record (column 1, lines 20-28).

U.S. Pat. No. 8,428,810 for DATA MANAGEMENT SYSTEMS FOR COLLISION REPAIR COACHING, issued Apr. 23, 2013 to Farzam Afshar et al., refers to verification of repair steps (column 14, line 64, through column 15, line 12).

U.S. Pat. No. 6,543,007 PROCESS AND SYSTEM FOR CONFIGURING REPAIR CODES FOR DIAGNOSTICS OF MACHINE MALFUNCTIONS, issued Apr. 1, 2003 to Richard Gerald Bliley et al., shows use of teams in a repair environment (column 4, lines 45-58).

U.S. Pat. No. 7,783,507 for SYSTEM AND METHOD FOR MANAGING A FLEET OF REMOTE ASSETS, issued Aug. 24, 2010 to Louis A Schick et al., also references service teams (column 13, line 60, through column 14, line 45).

U.S. Pat. No. 4,404,639 for AUTOMOTIVE DIAGNOSTIC SYSTEM, issued Sep. 13, 1983 to John F. McGuire et al., shows method and apparatus for diagnosing and servicing automotive vehicles.

U.S. Pat. No. 6,263,322 for INTEGRATED AUTOMOTIVE SERVICE SYSTEM AND METHOD, issued Jul. 17, 2001 to Tom Kirkevold et al., shows an integrated repair shop network (Abstract).

U.S. Pat. No. 8,818,976 for METHOD FOR ENHANCED VEHICLE SERVICE, issued Aug. 26, 2014 to Matt McDermott et al., shows a method of enhanced vehicle service, focusing on customer-repair-facility communications.

U.S. Pat. No. 8,370,018 for AUTOMOTIVE DIAGNOSTIC PROCESS, issued Feb. 5, 2013 to Keith Andreasen et at, shows a statistical likelihood approach to diagnostics. Andreasen et al. also have an additional, similar U.S. Pat. No. 8,019,503.

U.S. Pat. Nos. 7,376,497 and 7,734,390, both for USE OF AUTOMOTIVE DIAGNOSTIC CONSOLE TO DIAGNOSE VEHICLE, issued to Leon C. Chen, May 20, 2008 and Jun. 8, 2010, respectively, show owner focused systems.

U.S. Pat. No. 6,560,516 for METHOD FOR CONDUCTING VEHICLE DIANOSTIC ANALYSIS USING DISTRIBUTED STRUCTURE, issued May 6, 2003 to Michael L. Baird et al. is on general interest.

U.S. Pat. No. 7,209,817 for DIAGNOSIS AND REPAIR SYSTEM AND METHOD. Issued Apr. 24, 2007 is of general interest.

U.S. Pat. No. 7,590,476 for VEHICLE DIAGNOSIS SYSTEM AND METHOD, issued Sep. 15, 2009 is of general interest.

Japanese Patent No. JP2002123630 for AUTOMOBILE DAMAGE REPAIRING SYSTEM AND AUTOMOBILE DAMAGE ESTIMATING AND REPAIRING METHOD, published Apr. 26, 2002 is of general interest.

None of the patents, taken singly, or in any combination are seen to teach or suggest the Verified Motor Vehicle Repair Process of the present invention.

### SUMMARY OF THE INVENTION

In accordance with the present invention there is provided a systematized process to ensure that motor vehicle problems are properly diagnosed, properly repaired, and properly invoiced.

The novel method in accordance with the invention is typically a nine step process. The first step involves interaction with a vehicle owner (customer) who is presenting a vehicle for repair. A customer interview is performed, which includes recording the customer's description of the problem, and obtaining contact information for a new customer, or verifying information for an existing customer.

All problems are verified before a repair estimate is generated. Problem verification (step 2) typically involves a test drive of the vehicle by a service technician to verify first-hand the evidence of the complaint described by the customer. If available, the customer may accompany the technician on the test drive.

If a customer reported problem cannot be replicated or located, the customer is again involved for further dialog with the service writer. One possible outcome of this process is advising the customer to postpone repair until the problem more clearly (e.g., less intermittently) presents itself.

Given that the customer complaint is able to be verified by the service technician, during step 3, a hierarchy of tech support may be drawn upon in cases of problems that potentially have several possible causes to determine the most likely cause. The specific service history of the vehicle, as well as any available technical service bulletins, are reviewed to determine if they may offer any information relevant to the complaint and/or diagnosis.

In step 4, the service technician may perform additional inspections, testing, or evaluations to assist in completing a thorough diagnosis, based on his knowledge and experience, or on supplemental information obtained from the vehicle service history, service manuals, or technical service bulletins.

Next, in step 5, the initial service technician (hereafter referred to as the “work” technician) confers with a second “check” technician, reviewing the customer complaint and symptoms, the details of the diagnosis, and the recommendations to enact a repair. At this step, the check technician may agree with the diagnosis and recommendations, provide additional recommendations for further evaluation, or disagree with the entirety of the analysis. In the event of the latter result, an additional ‘tie-breaker’ technician may be called upon to resolve a deadlock. Once a problem diagnosis is agreed upon, typically by a “work” technician and a “check” technician, a repair estimate is generated and presented to the customer in step 6. The customer then must approve the estimate before any repair work begins.

Repairs are then performed (step 7) by a “work” technician who consults well-known references, typically a service manual, for the proper repair procedure.

Depending upon the complexity of the repair, a check technician may make intermediate inspections of the work technician's work. In step 8, the check technician makes a final check at the completion of the work and verifies the repair.

Finally, in step 9, a post-repair test drive is performed to ensure that the customer complaint has been addressed, and the symptoms identified in the initial test drive and/or diagnosis steps have been resolved. An invoice is generated and the work technician first reviews the invoice and then the check technician also reviews the invoice.

If additional problems are discovered during repair verification process, the vehicle may be given an additional test drive. If the test drive confirms that there is an additional problem with the vehicle, the newly-discovered problem is discussed with the customer. If the customer wishes the problem to be fixed immediately, a new job ticket is created and the vehicle is returned to the repair process. If no new problems are verified during the test drive, the vehicle is returned to the customer upon payment of the invoice.

The process of the invention may be implemented in computer software so that each vehicle is uniquely identified by a machine readable identification tag or device, as are all service personnel who may potentially be working on the vehicle. Preferable, RFID tags are used because of their insensitivity to grease, oil, and other grime typically found on vehicles and in a repair facility.

RFID tag readers are used to record the start of each of the processes of the novel method. A time stamp is associated with each RFID read.

Reports may be generated regarding the duration of each phase (i.e., task) of the repair process. Among many other possible reports, productivity of employees may be evaluated using data gathered.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a simplified flow chart showing the steps of the Verified Motor Vehicle Repair Process in accordance with the invention;

FIG. 2 is a simplified flow chart of the Interview Customer process of FIG. 1;

FIG. 3 is a simplified flow chart of the Verify Complaint/Test Drive process of FIG. 1;

FIG. 4 is a simplified flow chart of the Review Service History process of FIG. 1;

FIG. 5 is a simplified flow chart of the Perform Diagnosis process of FIG. 1;

FIG. 6 is a simplified flow chart of the Approve Diagnosis process of FIG. 1;

FIG. 7 is a simplified flow chart of the Obtain Customer Approval for Repair process of FIG. 1;

FIG. 8 is a simplified flow chart of the Perform Repair process of FIG. 1;

FIG. 9 is a simplified flow chart of the Verify Repair process of FIG. 1;

FIG. 10 is a simplified flow chart of the Invoice, Audit and Additional Test Drive process of FIG. 1;

FIG. 11 is a simplified flow chart of the Return Vehicle to Customer process of FIG. 1;

FIG. 12 is a simplified system block diagram of one embodiment of a computer system capable of implementing the system;

FIG. 13 is a representative image of a typical Job Ticket;

FIGS. 13A and 13B are partial schematic block diagrams comparing the implementation of paper job tickets and machine readable job tickets, respectively;

FIG. 14A is a simplified flow chart of a “badging” process forming a part of a computerized embodiment of the invention;

FIGS. 14B-14H are screen shots showing several representative steps of the “badging” process of FIG. 14A;

FIG. 15 is a modified, simplified flow chart of the Interview Customer process of FIG. 1;

FIG. 16 is a modified, simplified flow chart of the Verify Complaint/Test Drive process of FIG. 1;

FIG. 17 is a modified, simplified flow chart of the Review Service History process of FIG. 1;

FIG. 18 is a modified, simplified flow chart of the Perform Diagnosis process of FIG. 1;

FIG. 19 is a modified, simplified flow chart of the Approve Diagnosis process of FIG. 1;

FIG. 20 is a modified, simplified flow chart of the Obtain Customer Approval for Repair process of FIG. 1;

FIG. 21 is a modified, simplified flow chart of the Perform Repair process of FIG. 1;

FIG. 22 is a modified, simplified flow chart of the Verify Repair process of FIG. 1;

FIG. 23 is a modified, simplified flow chart of the Invoice, Audit and Additional Test Drive process of FIG. 1;

FIG. 24 is a modified, simplified flow chart of the Return Vehicle to Customer process of FIG. 1; and

FIG. 25 is a representative image of a typical Rear View Mirror Hanger.

### DETAILED DESCRIPTION OF THE PREFERRED EMBODIMENT

The present invention provides a systematized process to ensure that motor vehicle problems are properly diagnosed, properly repaired, and properly invoiced. The customer is always involved so that the repair process remains completely transparent. Each step of the repair process relies upon accountability and oversight. Actual diagnosis and repair work involves at least two technicians: a “work” technician and a “check” technician. When there is disagreement between a work technician and a check technician, a third technician is consulted.

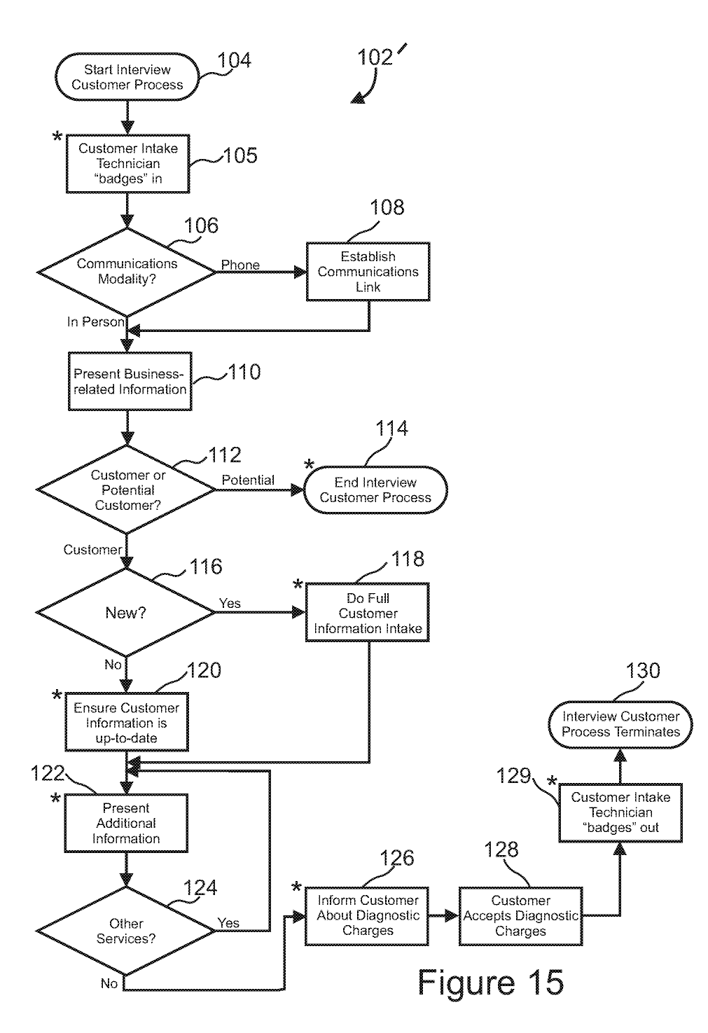

In one embodiment of the novel system, the process is computerized adding additional checks to ensure no step is overlooked. In FIGS. 15-24, an * appears beside certain blocks on the simplified flow charts. The * indicates that a “badging” operation is required before starting the operation and, most likely, at the end of the operation. A “badging” operation consists of reading the Electronic Job Ticket, reading the employee badge, and indicating the process step that is being started. The “badging” operation is discussed in more detail hereinbelow.

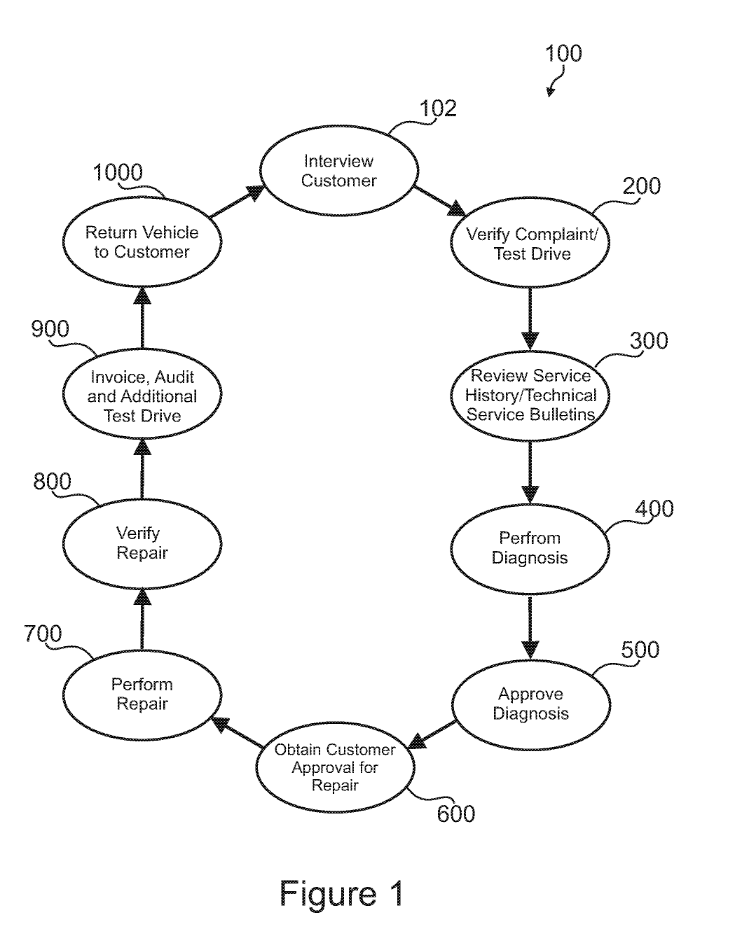

Referring first to FIG. 1, there is shown a high-level, simplified flow chart of a first embodiment of the method and system of the invention, generally at reference number 100.

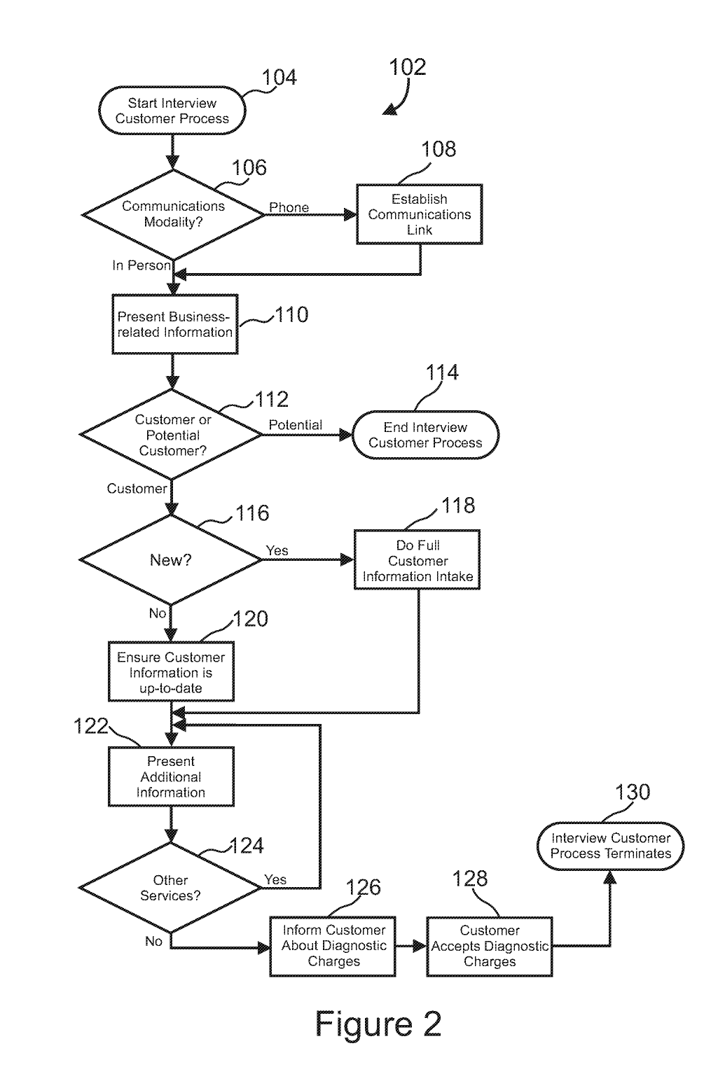

The first step shown in FIG. 1 is the Interview Customer step 102. Referring now also to FIG. 2, there is shown a simplified flow chart of the Interview Customer process 102.

The interview Customer process 102 may be conducted in-person, typically at the vehicle repair facility, or by phone. As used herein the term “by phone” is considered to include any remote communication method or technology, for example an audio/video communication using a system such as Skype™

The Interview Customer process 102 is started, block 104.

The modality of the Customer Interview is first determined, block 106.

If a “by phone” Customer Interview is selected, block 106, a communication link is next established, block 108. It should be noted that either a business representative (not specifically identified) performing the Interview, or the potential customer may establish the communications link, block 108.

During the Interview Customer process 102, the business representative has an opportunity to present the customer/potential customer information regarding the business, block 110. For example, he/she may discuss shop policies and manage customers' expectations. The business may wish to make the customer/potential customer aware of where they might be in the repair schedule/queue. Also, the business may wish to inform the customer/potential customer of business practices, as they relate to the repair of the vehicle.

For example, in an attempt to make the vehicle repair process transparent to the customer, the customer may be informed that certain procedures will only be performed a certain way along with an explanation regarding why this is done. In some vehicle repair businesses, these are called “Best Practices”. Best Practices are sometime learned the hard way after trying many alternative approaches to a particular repair. Best Practices may be codified in a written document or in a database forming part of an automated implementation of the novel method of the invention.

If a potential customer does not choose to become a customer, block 112, the process ends, block 114. If a potential customer decides to become a customer, block 112, control is transferred to block 116.

If a customer is a new customer, block 116, a complete information intake is performed, block 118. Customer information may be gathered by the customer filling out a paper form or by the business representative entering verbal information from the customer directly into a computer system.

If the customer is an existing customer, block 116, check is made, block 120, to ensure all customer information is up-to-date.

Among the information gathered, block 118, or verified, block 120 is the preferred way the customer desires to be contacted. Options typically are phone, text, or e-mail. It will be recognized by those of skill in the art that alternate communications devices, modalities, or methods may also exist. Consequently, the invention is not considered limited to the modalities discussed for purposes of disclosure. Rather the invention is intended to include any and all possible communications modalities.

Once the “housekeeping” tasks (i.e., ensuring that customer information is up-to-date, blocks 118, 120) are complete, it is time to discuss the problem for which the customer has brought his/her vehicle to the vehicle repair business, block 122.

The customer is asked to describe in detail the symptom or complaint for which his/her vehicle has been brought in for service. It is imperative that the customer be encouraged to provide as much detail regarding the complaint as possible.

Several situations may occur. One possible situation is when a customer requests a price to have a specific part replaced or serviced. In this case, it important that the business representative determine the customer's motivation for the request. Does the customer wish to maintain the requested part or is the customer self-diagnosing a problem and assuming a solution therefor?

If a customer asks to provide their parts, the business's policy must be clearly stated.

Once the complaint is described, the customer may be asked if there is anything else the vehicle needs and/or are there any additional complaints that the customer wishes to have diagnosed, block 124.

If there are additional service needs, control is returned to block 122 where the needed additional service is added to the information regarding the complaint. Otherwise, the customer is informed about any diagnostic charges, block 126.

The customer authorizes any diagnostic charges for the original or multiple complaint(s), block 128, and the customer is informed that an estimate for any necessary work will be presented for approval by the customer before any repair work will be started.

The customer may be informed regarding how he/she will be kept informed of the status of the vehicle repair(s) using the customer-specified preferred communications modality. Alternatively, the customer may be given instructions to call the repair business at a predetermined time to avoid requiring service personnel needing to call customers.

The Interview Customer process 102 then terminates, block 130.

As shown in FIG. 1, the next process after completing the Interview Customer process 102 is the Verify Complaint/Test Drive process 200.

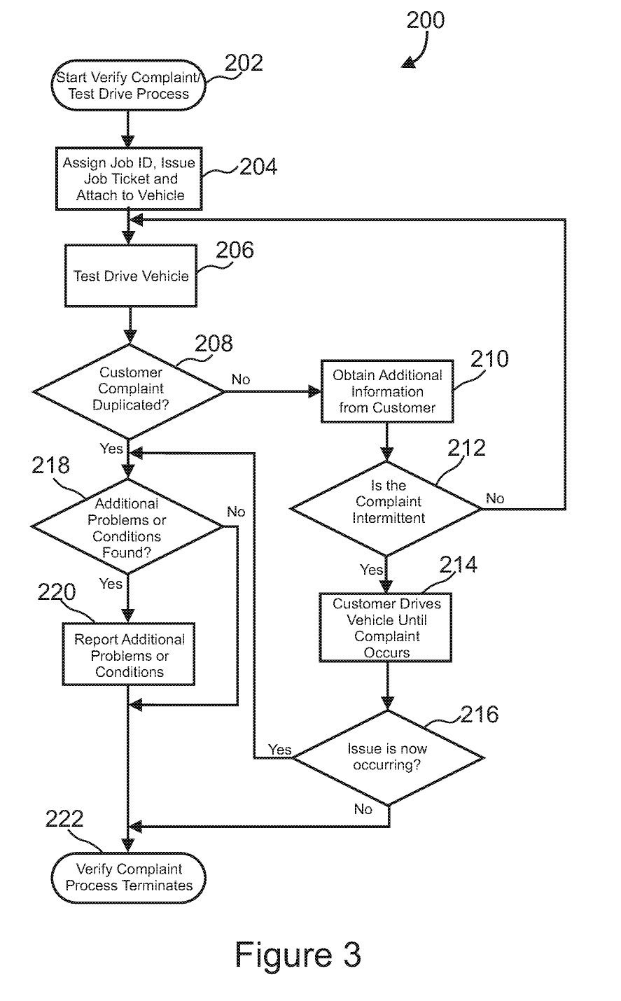

Referring now also to FIG. 3, there is shown a simplified flow chart of the Verify Complaint/Test Drive process 200.

The Verify Complaint/Test Drive is started, block 202.

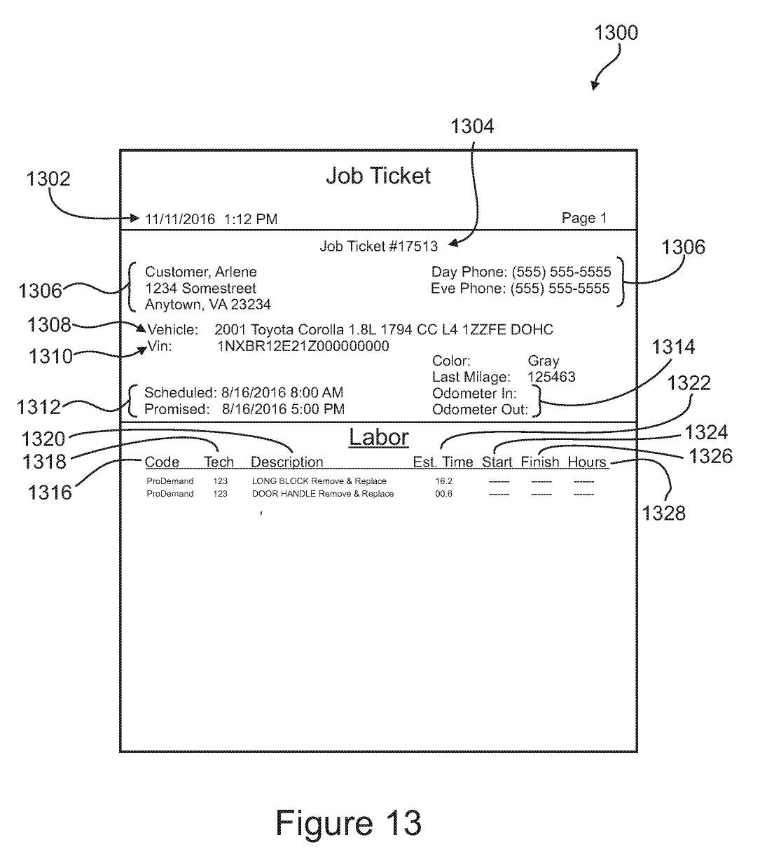

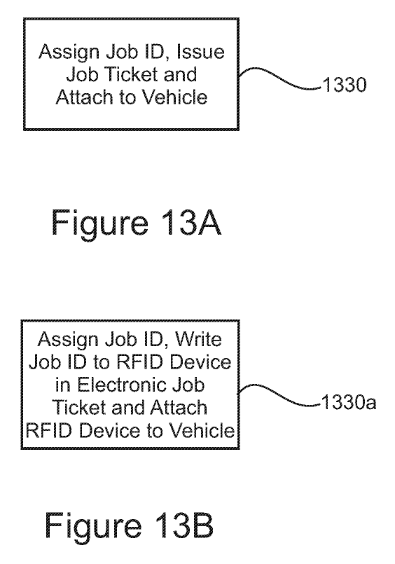

A Job ID for the vehicle repair is generated and a Job Ticket is generated, block 204. The Job Ticket is attached to the vehicle. One practice is to attach the Job Ticket to a fixed portion of the vehicle, for example, the side mirror on the driver's side of the vehicle. A typical Job Ticket is shown in FIG. 13. The use of a paper job ticket 1300 is summarized in FIG. 13 at reference number 1330.

In computerized embodiments, in addition to or in replacement of the physical Job Ticket, a machine readable “Electronic Job Ticket” (EJT) is also prepared and placed in or on the vehicle. The EJT electronically reproduces all information normally found on a paper Job Ticket. The use of an EJT is summarized in FIG. 13B at reference number 1330a.

Typically the vehicle is test driven by a qualified service technician to verify customer's complaint, block 206. This service technician listens for any unexpected sounds and observes any unusual vehicle operational issues, warning lights, or inoperative component. On the test drive, the vehicle may be driven over a known “speed bump” while listening for any tell-tale suspension noises. All interior accessories including air conditioning and heating may be tested. A video camera, still camera, and/or an audio recorder may be used to document any unusual visual or auditory event. Any photos, videos, or audio recordings may be shared with the customer as part of keeping the vehicle repair process completely transparent to the customer.

If the customer complaint can't be duplicated, block 208, the customer may be contacted and asked for additional information regarding his/her complaint, block 210. Typical information that may be requested includes: when does this problem happen, is it when the vehicle is cold or warmed up, at what speed, does the problem occur when steering straight ahead or when the vehicle is turning, and how many miles do you have to drive before it happens?

If the problem is intermittent, and unable to be diagnosed or validated, block 212, the vehicle is returned to the customer, block 214 and he/she is instructed to drive the vehicle until the complaint re-appears or gets worse.

If the problem occurs as the customer drives, block 216, control transfers to block 218. If the customer drive does not result in the re-appearance of the complaint, block 216, control is transferred to block 222.

If, however, the customer complaint can be duplicated, block 208, control is transferred to block 218.

If additional problems or conditions (e.g., maintenance concerns) are encountered, block 218 during the test drive, block 206, these additional problems are reported, block 220 and control is transferred to block 222.

If, however, no additional problems have been encountered, block 218, control is transferred to block 222.

The Verify Complaint/Test Drive process 200 is terminated, block 222.

As shown in FIG. 1, the next process after completing the Verify Complaint/Test Drive process 200 is the Review Service History process 300.

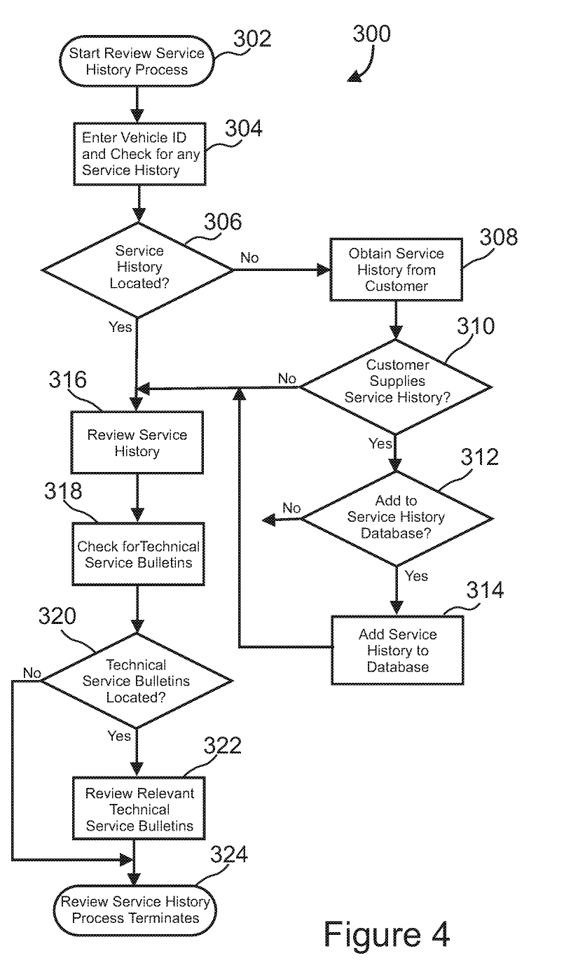

Referring now also to FIG. 4, there is shown a simplified flow chart of the Review Service History process 300.

The Review Service History and Technical Service Bulletins is initiated, step 302.

Most commonly used software systems in the vehicle repair industry incorporate a service history function. If a particular customer vehicle has been serviced by the facility over a long period of time, the service history may be extensive. If this is the first visit of a customer or a first visit of an existing customer with a different vehicle, the service history may be non-existent.

Identification information, typically a Vehicle Identification Number (VIN) is used to locate the service history, block 304.

If service history for the customer's vehicle exists, block 306, it may be reviewed, if however, no service history is located, the customer may be asked to provide relevant service history, block 308.

If the customer provides at least some service history for the vehicle, block 310, a decision must be made concerning adding the obtained service history to the service history database, block 312. If a decision is made to add the data to the database, block 312, the service history is added, block 314. After adding the service history, control is transferred to block 316.

If a decision is made not to add the obtained service history to the database, block 312, control is transferred directly to block 316.

After service history is reviewed, block 316, a search is made for any Technical Service Bulletins pertinent to diagnosing the complaint, block 318. Service Bulletins are frequently issued to address problems relating to a particular vehicle make and model. If several people have encountered the same problem in a particular make and model of vehicle and the manufacturer knows about it, there is a high probability that a Technical Service Bulletin exists.

Technical Service Bulletins are typically provided by a web-based subscription service. For purposes of disclosure, a product called Indentifix® is used to provide Technical Service Bulletins. Indentifix® forms a part of Direct-Hit® system, Repair Hotline service and Direct-Shop® shop management system and is available from Indentifix, headquartered in Roseville, Minn. Indentifix is owned by Solera Holdings.

While Indentifix® has been chosen for purposes of disclosure, many other similar and competing systems are believed to be known to those of skill in the art. Consequently, the invention is not considered limited to the Indentifix® system but is intended to include any and all suitable competing systems for providing Technical Service Bulletins.

A few examples of service bulletin topics include:
APPROVED PAINT MATERIALS FOR WARRANTY REPAIRS COOLING SYSTEM-MOTORCRAFT PREMIUM GOLD ENGINE CO ENGINE-STRAIGHTEDGE PROCEDURE FOR CHECKING CYUN SURGE/ROLLING IDLE-GEAR DRIVEN SYNCHRONIZERS ERRATIC OPERATION OF THE COOL/WARM FUNCTION Of THE MOTORCRAFT PREMIUM GOLDENGINE COOLANT-SERVICE GRUNTING NOISE FROM FRONT POWER WINDOW AFTER GLASS IDLE AIR CONTROL (IAC) VALVE DIAGNOSTIC SERVICE TI PAINT-NO CLEARCOAT BLENDING-COLLISION MANUAL

If any relevant Technical Service Bulletins are located, block 320, they are reviewed, block 322, and control is then transferred to block 324. Recall issues are also addressed during the review of Technical Service Bulletins, block 322.

If no relevant Technical Service Bulletins are located, block 320, control is transferred directly to block 324.

The Review Service History process then terminates, block 324.

As shown in FIG. 1, the next step in the process is performing the actual diagnosis of the verified problem 400.

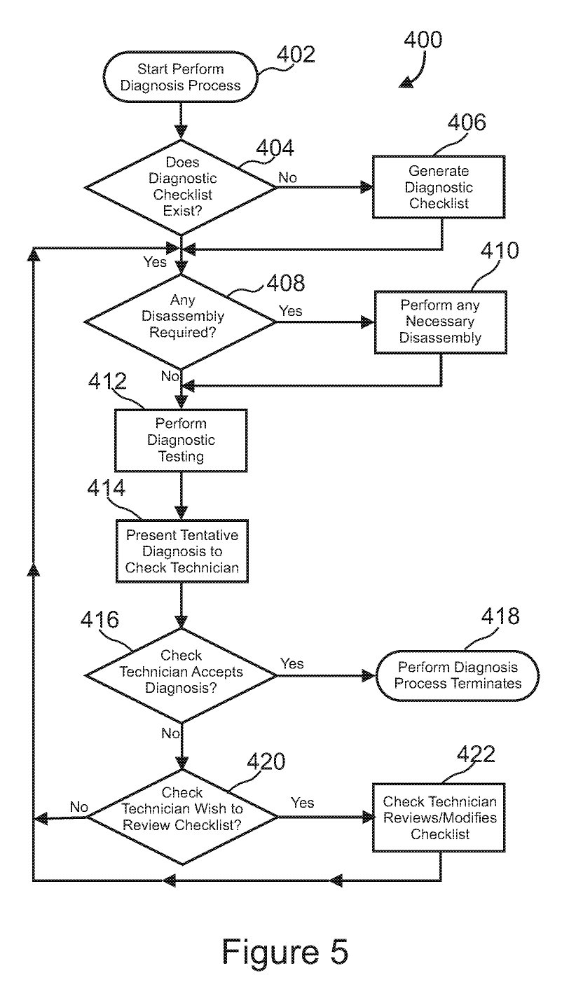

Referring now also to FIG. 5, there is shown a simplified flow chart of the Perform Diagnosis process 400.

The Perform Diagnosis process is started, block 402.

All diagnostic and actual repair work performed in accordance with the method of the invention uses at least two services technicians: a work technician who performs the actual diagnostic or repair work and a check technician who checks the diagnostic or repair work performed by the work technician. For complex repairs, more technical support personnel may be involved. It is assumed that both the work technician and the check technician know how the suspect system or component works and are trained on all necessary diagnostic tools.

Diagnosis is performed using an appropriate diagnostic checklist, typically generated using the results of the Review Service History process 300. If a diagnostic checklist has not already been generated, block 404, a diagnostic checklist is then generated, block 406. Typically, appropriate keywords are used based on the symptoms of the problem being diagnosed. On-line databases may be queried to generate the diagnostic checklist. Such on-line databases are believed to be well known to those of skill in the art and, consequently are neither described nor discussed further herein. Control is then transferred to block 408.

If some or full disassembly is required to enable system or component diagnosis, block 408, that disassembly is performed, block 410. After disassembly, block 410, control is transferred to block 412.

Using the diagnostic checklist, the work technician performs diagnostic testing using test equipment and techniques believed to be well known to those of skill in the vehicle repair art, block 412.

Once diagnostic testing by the work technician has progressed to a point where the work technician has reached a tentative diagnosis, block 412, the tentative diagnosis is provided to the check technician, block 414.

If the check technician concurs with the tentative diagnosis of the work technician, block 416, control is transferred to block 418 and the Perform Diagnosis process is terminated.

If, however, the check technician does not concur with the tentative diagnosis of the work technician, block 416, the check technician may choose to review the diagnostic checklist, block 420.

If the check technician chooses to review the diagnostic checklist, block 420, he/she reviews and possibly modifies the diagnostic checklist, block 422. Control is transferred to block 408.

If, however, the check technician does not review the diagnostic checklist, block 420, control is transferred to block 408.

The work technician then continues the diagnosis process (blocks 408-414) until the check technician concurs with the tentative diagnosis, block 416.

Once the Perform Diagnosis process 400 is complete, the next step shown in FIG. 1 is the Obtain Approval for the diagnosis 500.

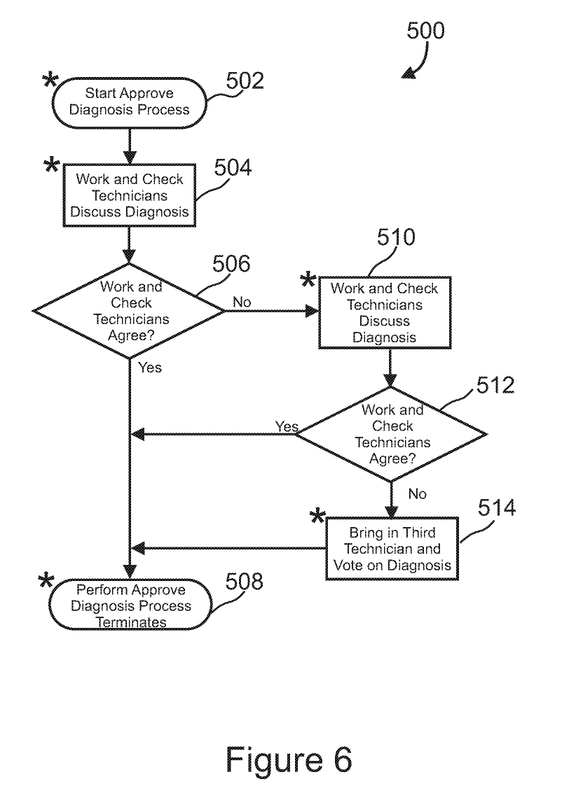

Referring now also to FIG. 6, there is shown a simplified flow chart of the Obtain Diagnosis Approval 500.

The Diagnosis Approval process is begun, block 502.

The work technician first shares his diagnostic results with a check technician and the technicians may discuss the work technician's diagnosis, block 504.

If the check technician agrees with the diagnosis of the work technician, block 506, control is transferred to block 508 and the Obtain Diagnosis approval process is terminated.

If, however, the check technician does not agree with the diagnosis of the work technician, block 506, the work technician and the check technician further discuss the diagnosis, block 510. The check technician may offer an alternate diagnosis.

If the work technician and the check technician reach an agreement concerning the diagnosis, block 512, control is transferred to block 508 and the Approve Diagnosis process is terminated.

If however after further discussion the work technician and the check technician cannot agree upon a diagnosis, 514, a third technician is consulted. A vote is taken and the diagnosis winning two votes is accepted and control is then transferred to block 508 and the Approve Diagnosis approval process is terminated.

As shown in FIG. 1, the next process after completing the Approve Diagnosis process 500, the next step is the Obtain Customer Approval for the Repair process 600.

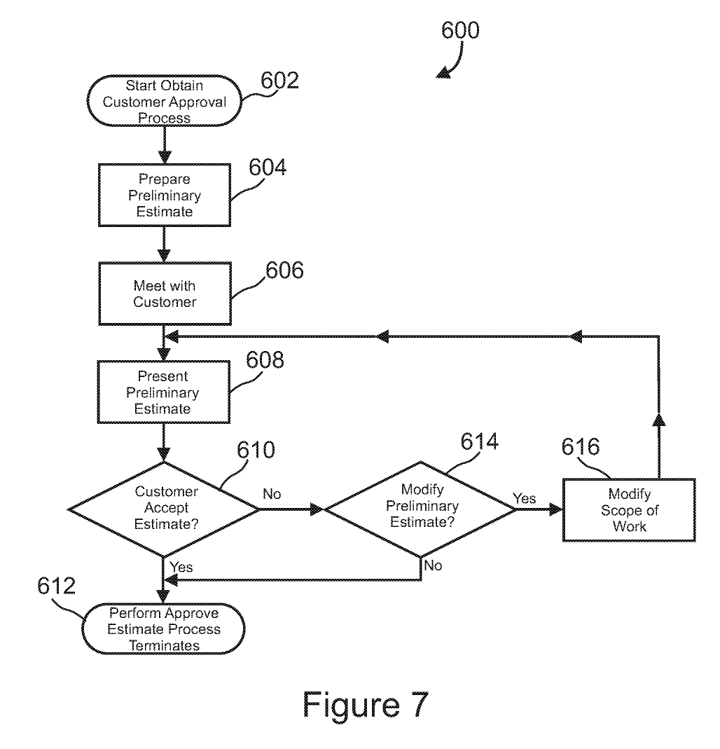

Referring now also to FIG. 7, there is shown a simplified flow chart of the Obtain Customer Approval for the Repair process 600.

The Obtain Customer Approval process begins, block 602. A key component in the Customer Approval process 600 is being able to communicate with the customer in real time, either via email, phone, or text message. Not being able to communicate with the customer delays the start of the repair. In addition, production in the repair shop may be disrupted. The tentative diagnosis is used to prepare a preliminary estimate of the cost of repairing the vehicle, block 604.

The business representative and/or the check technician next meet with the customer, block 606. The customer is informed of the tentative diagnosis of the presenting problem. The philosophy of the novel repair process is to make the customer a partner in the diagnostic process. For this reason, an explanation is provided of how technicians arrived at the tentative diagnosis by verifying testing in accordance with the diagnostic checklist. The description of the test equipment and the tests performed therewith may also be shared with the customer.

The preliminary estimate is presented to the customer for approval, block 608. The customer is informed that the diagnosis is tentative because the diagnostic process often continues throughout the repair process. As the work technician begins the repair(s), he/she may discover additional factors, for example other components that may need repair that were not discovered in the original Perform Diagnosis process 400. Additional repairs/replacements discovered will probably change the original estimate.

If the customer then approves the preliminary estimate, block 610, the Obtain Customer Approval process 600 is terminated, block 612.

If, however, the customer does not approve the preliminary estimate, block 610, it is possible that the repair facility may be willing to modify the work scope and/or the preliminary estimate, block 614.

If the repair facility agrees to modify the work scope and/or the preliminary estimate, block 614, agreed upon modifications to the work scope and/or the preliminary estimate are made, block 616, and control is then transferred to block 608.

Once the Obtain Customer Approval process 600 is complete, the next step shown in FIG. 1 is the Perform the Repair process 700.

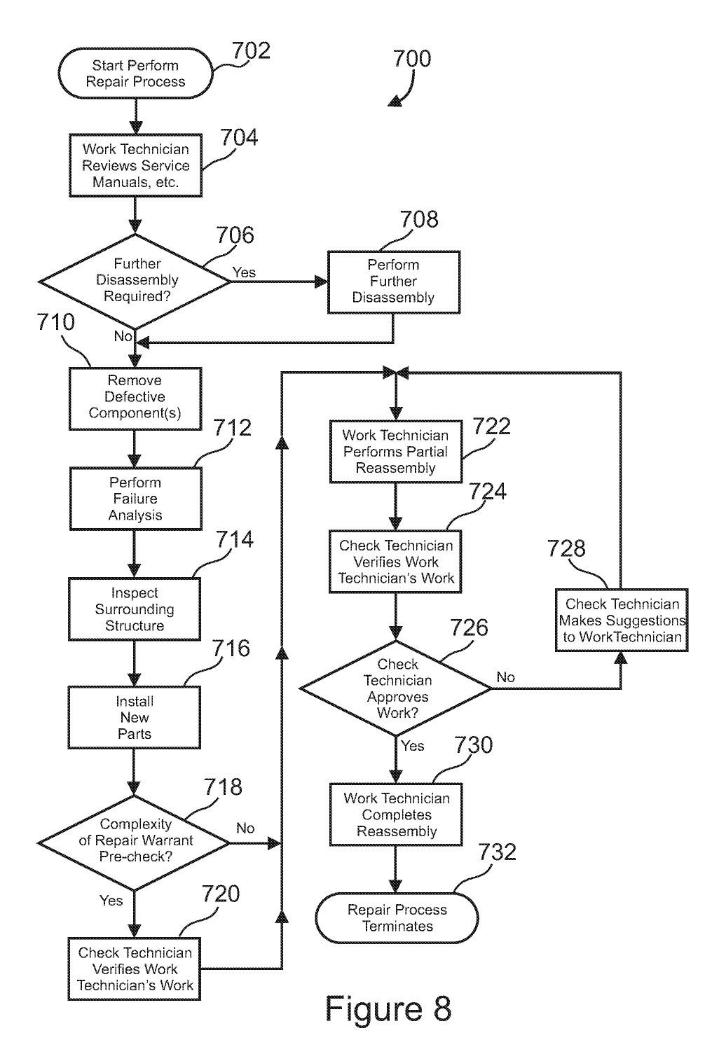

Referring now also to FIG. 8, there is shown a simplified flow chart of the Perform Repair process 700.

The perform repair process is started, block 702.

The work technician first reviews the relevant procedures provided in the manufacturer's service manual or other relevant documents, block 704.

If further disassembly is required (beyond the disassembly required in previous Perform Diagnostic step 400), block 706, the work technician performs the further disassembly, block 708.

After any required disassembly, block 708 any defective component(s) is/are removed, block 710.

After component removal a failure analysis may be performed. This may include comparing the old part(s) to the new part(s) to be installed, block 712, or inspecting the old part for signs of wear, corrosion, or other failure modes. Failure analysis is performed on the old part(s) to help verify that another factor did not contribute to the part's failure. This helps ensure that replacing the failed part with a new part is probably going to repair the problem.

All surrounding components and structures are inspected, block 714.

Depending on the complexity of the repair, as new part(s) is/are installed block 718, the check technician may be asked to inspect the work technician's work, block 720.

If however, the complexity of the repair does not warrant inspection by the check technician, block 718, control is transferred to block 722.

The work technician next does a partial re-assembly, block 722, leaving any bolt, stud, or screw not completely tightened in a state that makes their untightened status readily visible to both the work technician and the check technician. Some repair facilities recommending that untightened screws, studs, or bolts be left hanging approximately half way out.

The check technician checks the quality of work performed by the work technician, block 724.

If the check technician approves the work technician's progress, block 726, control is passed to block 730.

If the check technician fails to approve the work technician's progress, block 726, the check technician discusses the reason for his/her problem with the work and/or offers suggestions to the work technician for correcting the work, block 728 and control is transferred to block 722.

At block 730, the work technician completes the reassembly and then the Repair process terminates, block 732.

Once the Repair process 700 is complete, the next step shown in FIG. 1 is the Verify Repair process 800.

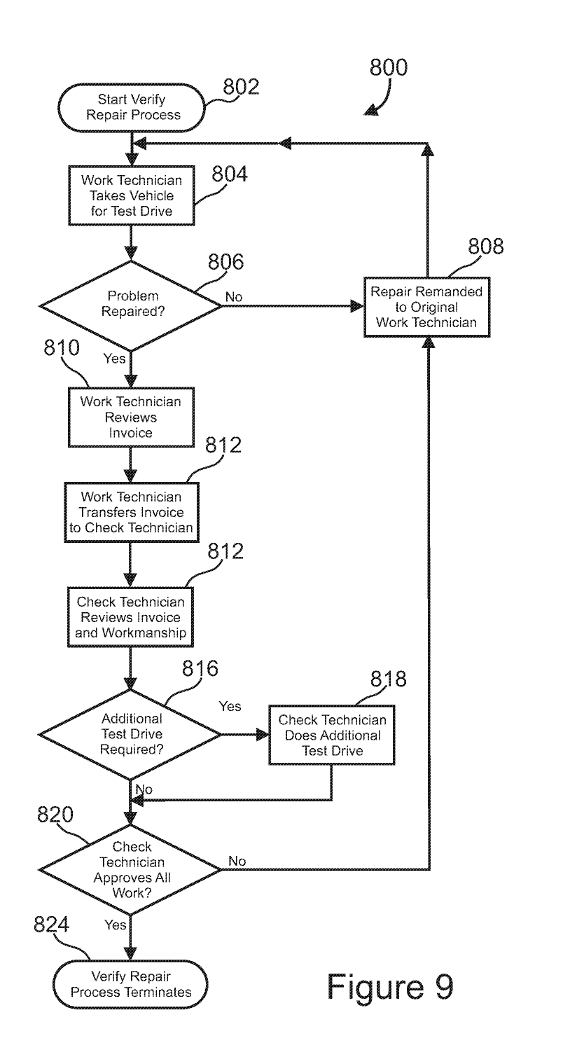

Referring now also to FIG. 9, there is shown a simplified flow chart of the Perform Repair process 800.

The Verify Repair process is used to determine that the vehicle problem presented by the customer has indeed been repaired. The Verify Repair process begins, block 802.

The work technician first, if appropriate, takes the vehicle for a test drive, block 804.

If the work technician believes that the customer problem has not been repaired, block 806, control is transferred to block 808 where the problem is remanded to the original work technician for further work. Control is then transferred to block 804, the Verify Repair process is begins again with another test drive, block 804. The process continues until the check technician is satisfied that the repair has been properly completed, block 820. The Verify Repair process is then terminated, block 824. The vehicle is returned to the Perform Repair step (700) of FIG. 1.

If the work technician believes that the problem has been repaired, block 806, the work technician reviews the invoice to ensure that all parts on a job ticket are included on the invoice. In addition, all notes from the job ticket should also be on the invoice. The invoice total is checked against the approved estimate, block 810.

The work technician transfers at least the invoice data to the check technician for his/her review block 812.

The check technician reviews at least the invoice, block 814 and also inspects the vehicle again for workmanship. If the nature of the repair warrants it, block 816, a second test drive is made by the check technician, block 818.

If the check technician verifies the invoice as well as workmanship, block 820 control is transferred to block 824 and the Verify Repair process 800 terminates.

If, however, the check technician has a problem with any aspect of the repair, block 820, the vehicle is re-assigned to the work technician, if available, block 808, for a re-work of the repair. If the work technician is not available, block 808, a new work technician is assigned. Control is then transferred to block 804, and progresses through the flow as previously described until block 824 is achieved, and the Verify Repair process 800 is terminated.

Once the Verify Repair process 800 is complete, the next step shown in FIG. 1 is the Invoice, Audit and Additional Test Drive process 900.

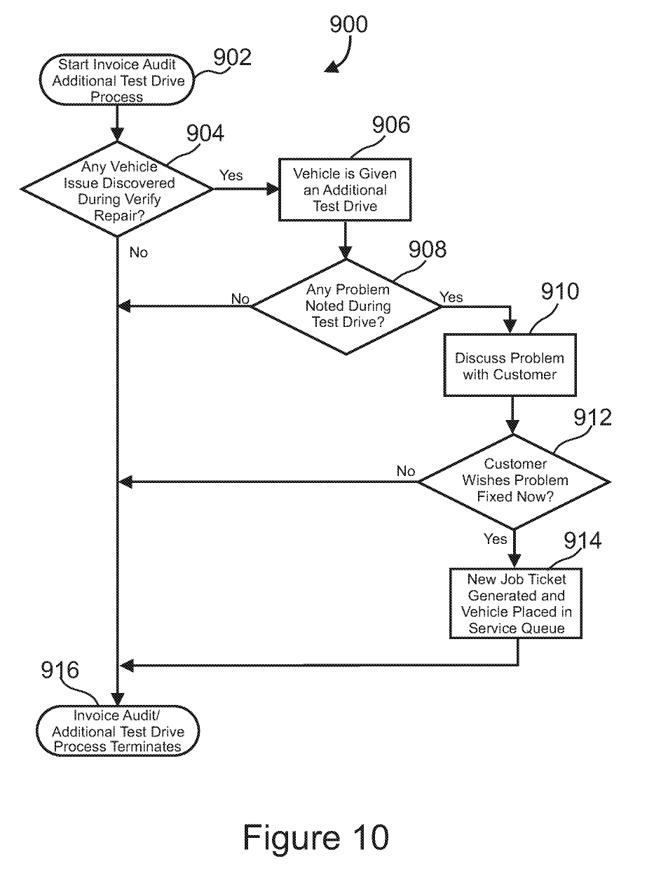

Referring now also to FIG. 10, there is shown a simplified flow chart of the Invoice, Audit and Additional Test Drive process 900.

The Invoice and Audit process is started block 902.

If the vehicle failed any of the quality assurance inspection discussed hereinabove, block 904, the vehicle is given another test drive, block 908. Any other deficiencies with the vehicle are noted and the customer is advised, block, block 910.

The customer is asked if he/she wishes to have the newly discovered problem repaired now, block 912. If the customer wishes to have the problem repaired now, block 912, control is transferred to block 914, otherwise control is transferred to block 916.

The invoice is audited, and work technician is questioned about the invoice to verify that it is correct and complete, including location of items repaired, (i.e.; left, right, front or rear), block 908.

The customer is notified that the vehicle is ready for pickup and, if necessary, old parts are made ready for inspection by the customer, block 910.

Once the Invoice, Audit and Additional Test Drive process 900 is complete, the next step shown in FIG. 1 is the Invoice, Return Vehicle to Customer process 1000.

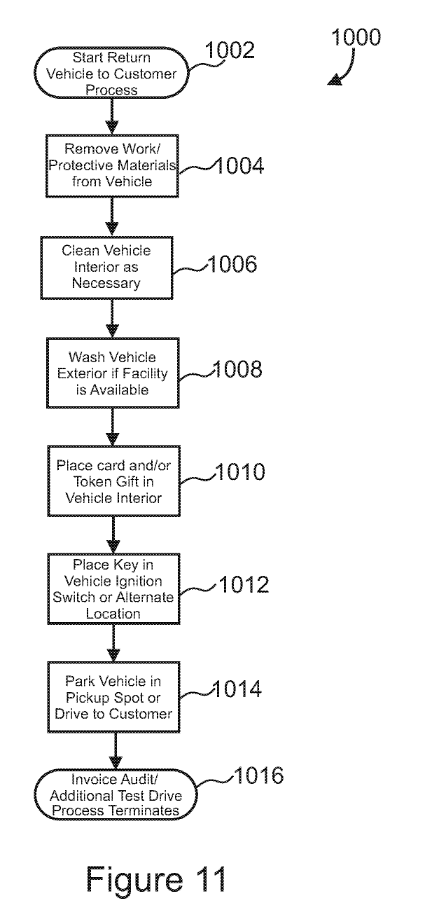

Referring now also to FIG. 11, there is shown a simplified flow chart of the Return Vehicle to Customer process 1000.

The Return Vehicle to Customer process is started, block 1002.

Prior to returning the customer's vehicle, all material such as seat protectors, floor protectors, etc. are removed from the vehicle, block 1004.

If necessary, at least portions of the vehicle's interior may be cleaned (e.g., vacuum cleaned), interior windows cleaned, etc., block 1006.

Some repair facilities have a car washing facility and the vehicle exterior may be washed, block 1008

A thank you card accompanied by a non-meltable candy or other token may be placed in the vehicle interior, block 1010.

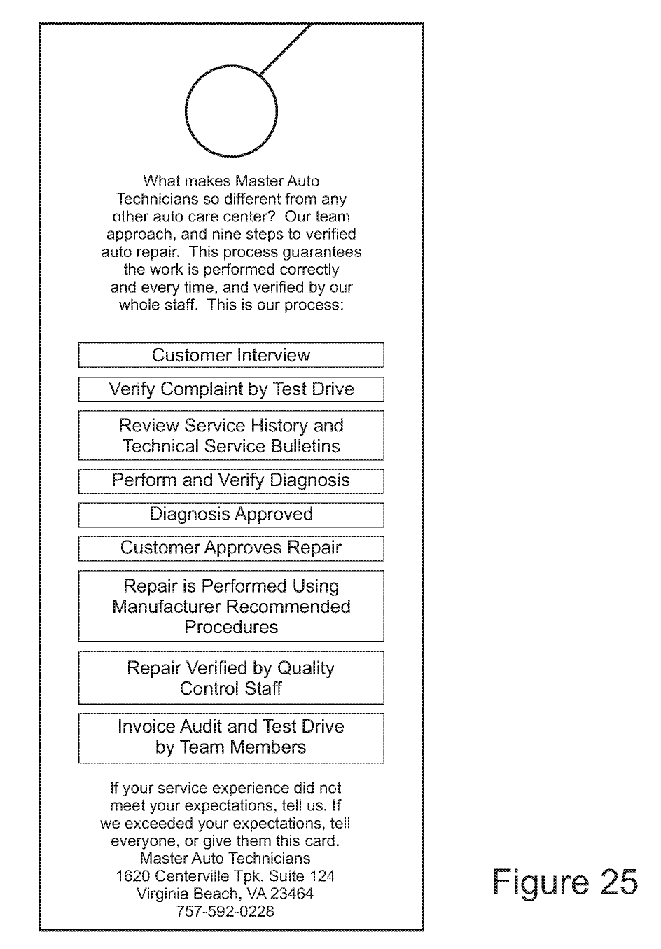

Additionally, a hanging document that describes the novel nine step process may be placed on the rear view mirror of the motor vehicle. A typical hanging document is shown in FIG. 25.

Vehicle key may be placed in the ignition switch or in an alternate location for vehicles with keyless ignitions, block 1012.

Vehicle is placed in customer pick-up location or alternately, an employee may drive the customer's vehicle to a pickup location, block 1014.

Finally the Return Vehicle to Customer process 1000 is terminated, block 1016.

The novel Verified Motor Vehicle Repair (VMVR) Process 100 as described provides a series of processes that help ensure that a vehicle is properly diagnosed and repaired. Throughout the process, the customer, presumably the vehicle owner is involved. No decisions are made to perform any repair or maintenance on the vehicle that the customer has not authorized.

However, many of the steps that involve multiple repair facility personnel must operate on an “honor” system for the system to be effective. For example, if validation of a work technician's work is supposed to be made, it would be easy for the work technician to forge a check technician's sign-off. It is possible to wrap computer software or possibly an “application” (i.e., an “app”) around the novel process to ensure each of the required steps has been carried out. As used hereinafter, the term “system” is used to refer to any computer software or application that implements the VMVR Process 100.

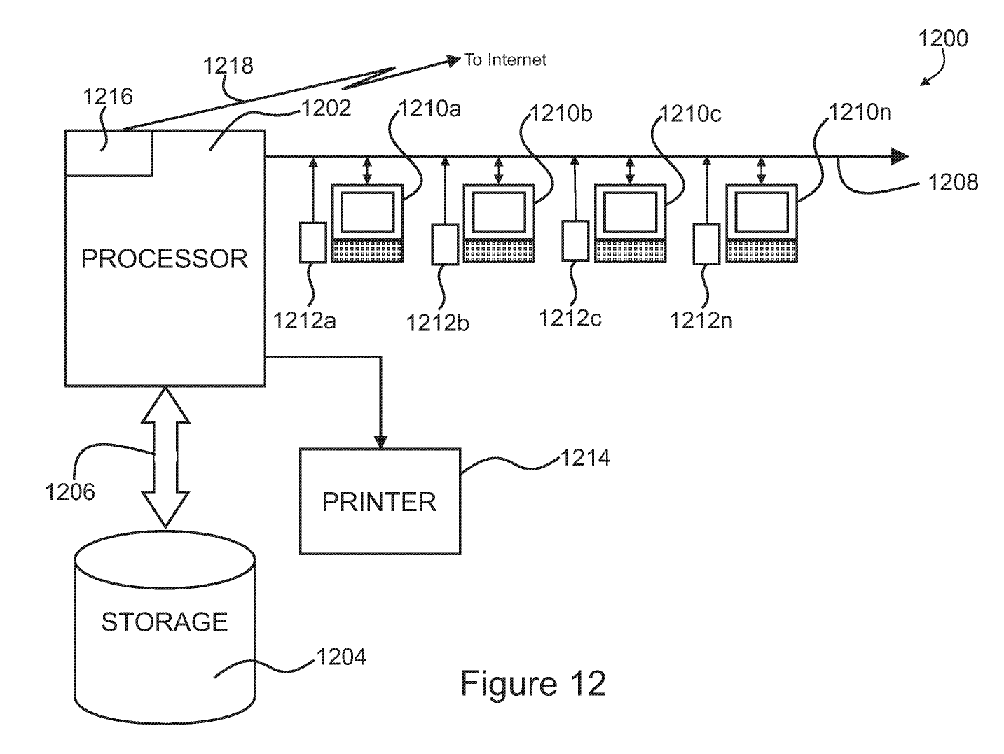

Referring now also to FIG. 12, there shown a simplified system block diagram of one embodiment of a computer system capable of implementing the method of the present invention, generally at reference number 1200.

A processor, block 1202, represents any computer processing arrangement, for example a single processor, multiple networked processors, or any other distributed processing arrangement.

A storage device 1204 is connected to processor 1202 by a storage bus 1206. Storage device 1204 may be a single storage device or alternately, may represent multiple networked storage devices. Storage device 1204 may be implemented either partially or in its entirety as a cloud storage device. As other storage arrangements may be known to those of skill in the art, the invention is not intended to be limited to storage arrangements. Rather, the invention is intended to include any other suitable storage arrangements in addition to those chosen for purposes of disclosure.

A network, shown schematically at reference number 1208 is operatively connected to processor 1202.

One or more work stations 1210a, 1210b . . . 1210n are connected to network 1208. Work stations 1210a, 1210b . . . 1210n may include a computer operator workstation, administrative workstation(s), repair shop work station(s), financial workstation(s), parts department workstation(s), and any other work stations required to effectively operate a vehicle repair business. None of these work stations are specifically identified.

Some or all of work stations 1210a, 1210b . . . 1210n may be equipped with a touchscreen 1216a, 1216b . . . 1216n. While illustrated in FIG. 12 with a keyboard 1218a, 1218b . . . 1218n, a keyboard may not be necessary for work stations equipped with touchscreens 1216a, 1216b . . . 1216n. Touchscreens 1216a, 1216b . . . 1216n with a durable (e.g., scratch resistant, chemical impervious, etc.) screen are preferred for the workshop environment.

Work stations 1210a, 1210b . . . 1210n could readily have associated peripheral devices, none shown. Such devices could include: pointing devices, desktop scanners, individual printers, cameras, microphones, speakers, etc. Such devices are believed to be well known to those of skill in the art and, consequently, are not further described or discussed herein.

Computer system 1200 includes a plurality of data readers 1212a . . . 1212n where each employee may read a badge having a magnetic strip, a bar code, an RFID device, or any other device known to those of skill in the art to identify the employee presenting the badge or other device at one of the data readers 1212a . . . 1212n. For purposes of disclosure, RFID devices are chosen because the vehicle repair facilities are typically dirty. Oil, grease or other dirt and grime associate with vehicle repair could readily soil a badge with a bar code or damage the magnetic strip of a magnetic stripe-equipped badge, thereby rendering the badge unreadable.

Radio-frequency identification (RFID) uses electromagnetic fields to automatically identify and track RFID tags attached to objects. The RFID tags contain electronically stored information, in this case, employee identification and possibly job classification. Unlike a barcode, the RFID tag need not be within the line of sight of the reader, so it may be embedded in the tracked object, and thereby protected from the dirty environment.

At least one printer 1214 is connected to processor 1202.

A communications controller 1216 portion of processor 1202 supports an Internet connection 1218.

By requiring all personnel involved with servicing a motor vehicle to verify with the software system by “badging” each recordable event in the process, overlooked steps, especially quality control steps can be avoided. By automatically including a time stamp with other captured information, the length of time required to perform each task may be analyzed.

For example, factors such as the time a work technician needs to wait for a check technician may be recorded and analyzed to help a repair business staff itself properly.

As each of the “check” events (e.g., verifying a diagnosis, verifying a repair, etc.) are logged with pertinent information about each of the work technician and check technician recorded, outright fraud would need to be perpetrated by one or more repair business personnel to “defeat” the check system.

Reports may ultimately be generated by the system and employee productivity rated. Such reports are described in more detail hereinbelow,

Each employee or contractor of a vehicle repair facility must be assigned an employee ID and assigned a job classification (e.g., work technician, check technician, etc.). An alternative to a job classification is a skill level or other similar classification. The purpose is to ensure that a person of adequate skill level/experience is checking the work of another (e.g., a work technician).

In addition, each employee may be assigned an access code allowing the access to only relevant areas of the system. For example, a work technician may not be authorized to access administrative functions.

At least the employee ID and the job classification/skill level is encoded in a machine readable device, preferably a picture badge with an embedded RFID device. In addition, other information such as employee authorization codes may also be included. As mentioned hereinabove, bar codes or magnetic stripe machine readable devices may be used but the RFID device is considered less prone to contamination or damage from workplace grease, oil, or other workplace contaminants.

Typically, a Job Ticket is associated with each motor vehicle repair. Referring now also to FIG. 13, there is shown an image of a typical Job Ticket, generally at reference no. 1300.

In a “paper” system, the Job Ticket 1300 is a paper document physically attached to the vehicle during the service process. Job Tickets 1300 typically contain a time stamp 1302. Each motor vehicle repair is assigned a unique number 1304.

Customer information 1306, including contact information is also included.

A vehicle description 1308 and a Vehicle Identification Number (VIN) 1310 are also included. It is possible that the vehicle description may be automatically obtained by “looking up” the VIN 1310.

Scheduled Time and Promised Time 1312, Vehicle color as well as odometer readings 1314 are also included.

Finally, records of the job are listed. For each entry there is a Code, 1316, a Technician ID 1318, a Description of the work 1320, a Time Estimate 1322 as well as actual Start Time, 1324, Finish Time 1326, and the Hours (i.e., elapsed time between the Start Time and the Finish Time) 1328 are all recorded.

In the computerized embodiment of the novel VMVR process 100, an Electronic Job Ticket is created by writing all pertinent information from Job Ticket 1300 into an RFID device. The Electronic Job Ticket is generally attached to the motor vehicle being serviced.

To utilize the tracking and verification features of the computerized version of the VMVR Process of the invention, at least four pieces of information are required by the system:
The Job/Vehicle Identification (from Electronic Job Ticket)
The employee Identification
The Operation identification; and
The Operation Starting or Stopping information.

This information is gathered by “badging” (i.e., reading the RFID devices from the Electronic Job Ticket and required employee “badges”).

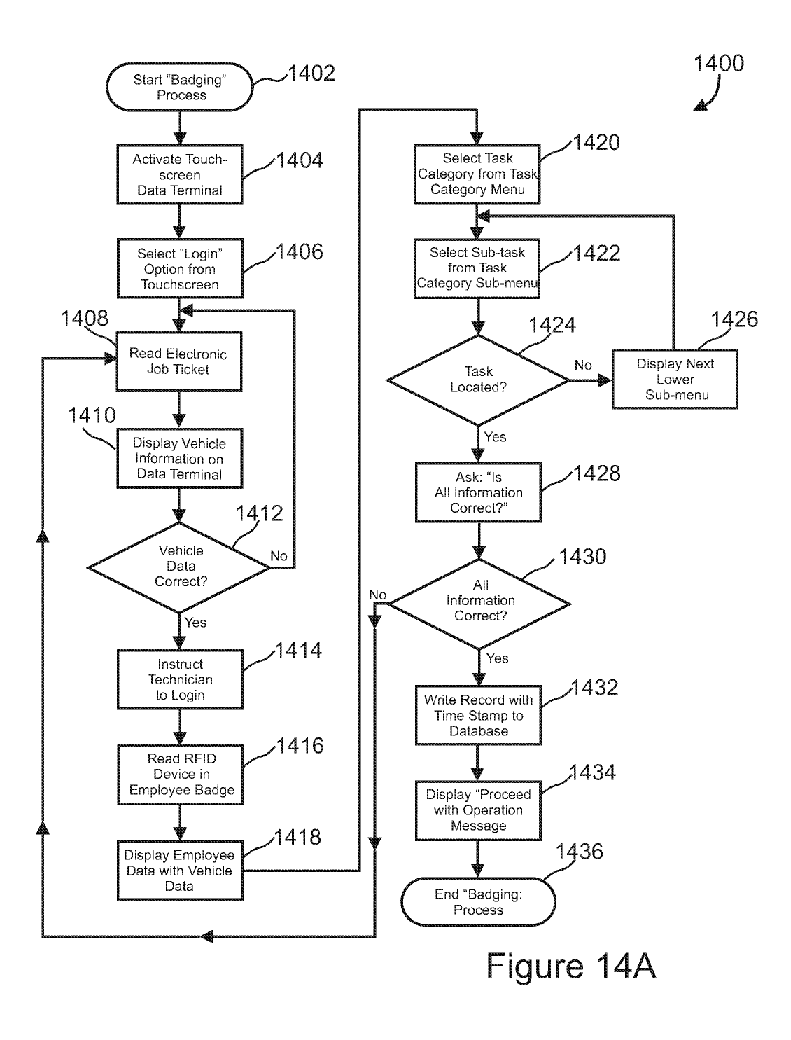

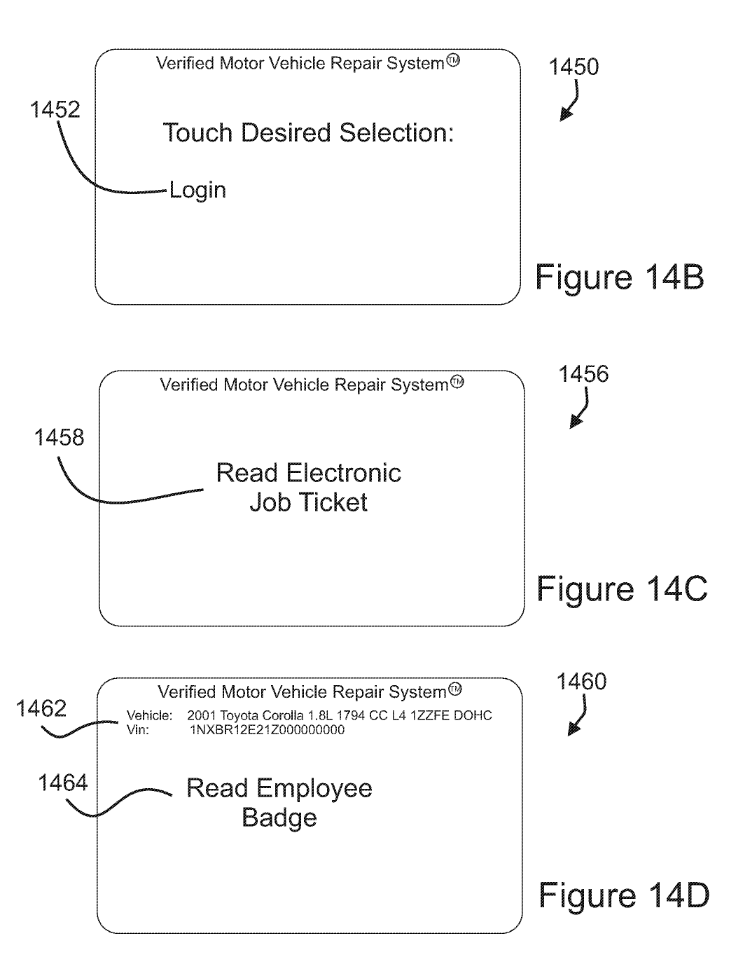

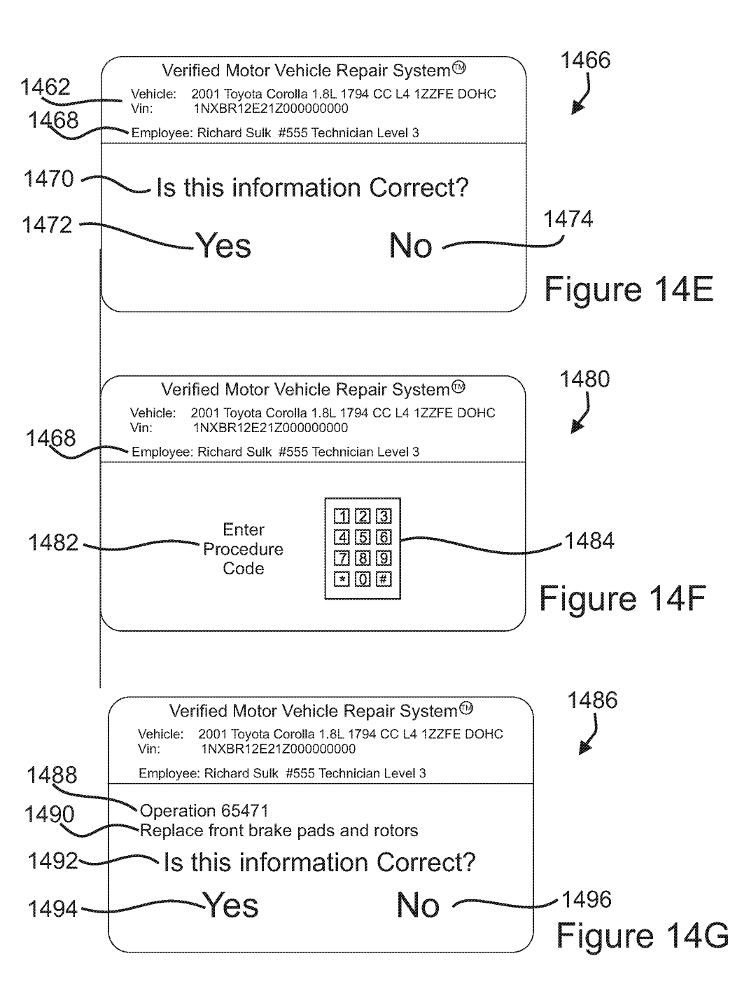

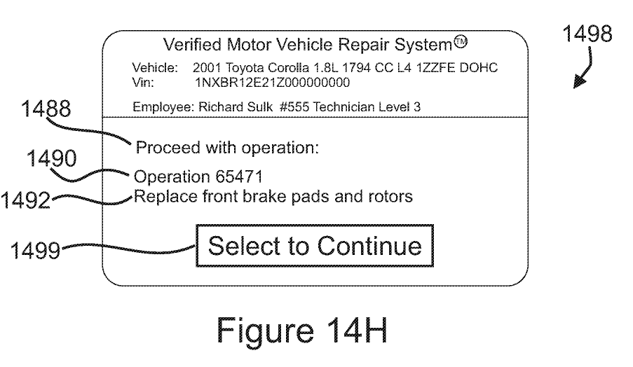

Referring now also to FIG. 14A, there is shown a simplified process flow diagram of a typical “badging” operation, generally at reference number 1400.

The “badging” process is begun, block 1402.

First, data terminal 1210a, 1210b . . . 1210n is assumed hibernating. Applying figure pressure anywhere on the touchscreen 1216a, 1216b . . . 1216n portion “awakens” the data terminal 1210a, 1210b . . . 1210n, block 1404. A menu screen is then displayed.

An abbreviated typical login screen is shown in FIG. 14B at reference number 1450. The user selects the “Login” option at a data terminal 1210a, 1210b . . . 1210n, block 1406.

When the user selects the “login” option 1452 from screen 1450, the user is transferred to screen 1456 of FIG. 14C where he/she is instructed to “Read Electronic Job Ticket”, 1458 (FIG. 14C), block 1408.

At least the Job Identification (ID) is obtained by reading the RFID device in the Electronic Job Ticket at the associated RFID reader 1212a, 1212b . . . 1212n.

When the Job ID is captured, the data terminal displays screen 1460, FIG. 14D. Screen 1460 displays the vehicle VIN 1462 and detailed vehicle information 1464 is displayed at the top of the screen 1216a, 1216b . . . 1216n of data terminal 1210a, 1210b . . . 1210n, block 1310.

The user is asked to verify at the touchscreen that the displayed vehicle information is correct, block 1312. This step is not illustrated on a corresponding screen shot. If the user indicates that the vehicle information is not correct, control is returned to block 1408 and the user may then read the correct Electronic Job Ticket, block 1408. If, however, the displayed vehicle information is correct, block 1312, control is passed to block 1314 and screen 1460 is displayed (see FIG. 14D).

The technician (or other employee) is instructed to “Read Employee Badge” 1464, FIG. 14D, block 1314.

The employee (e.g., the technician) then uses one of the RFID data readers 1212a . . . 1212n to scan the embedded RFID device in the employee badge, block 1316.

The employee data 1468 is then displayed along with the VIN and detailed vehicle information 1462 (FIG. 14E), block 1318. The employee must verify that the displayed employee information 1468 is correct, screen 1466, FIG. 14E. The employee touches “Yes” region 1472 (FIG. 14E) or “No” region 1474 (FIG. 14E).

If the employee touches “Yes” region 1472, the operation (i.e., task) to be conducted may now be entered.

Referring now also to FIG. 14F, there is shown a screen shot of a typical data entry screen 1480. Screen 1480 contains a numeric keypad on touchscreen 1216a, 1216b . . . 1216n. A message: Enter Procedure Code” 1482 is also displayed. The employee may enter a numeric procedure code directly at the keypad 1484. This is a greatly simplified embodiment of the invention.

Referring now also to FIG. 14G, there is shown a screen shot of a typical verify procedure code screen 1486. Once the employee enters a procedure code (screen 1480), the entered procedure code is looked up in a database and both the procedure code 1488 and a detailed description of the operation to which the entered procedure code pertains 1490 are displayed.

Once both the job (i.e., operation) 1488 code and a detailed description of the operation to which the entered procedure code pertains 1490, the employee is asked to answer the question: “Is this information correct?”. This is done by selecting the “yes” region 1494 or the “No” region 1496. If “yes” region 1494 is selected, a new screen is then presented.

Referring now also to FIG. 14H, there is shown a simplified screen shot of a “Proceed with Operation” screen, generally at reference number 1498. This screen merely verifies to the employee that it is OK to proceed with the signified operation.

A message 1499 “Select to continue” is displayed. Once selected, the operation is begun.

Alternately, the employee may use a series of steps, none illustrated, to find the required procedure code from a series of successive menus, none shown, where he/she can “drill down” until the precise procedure code is read. In the menu-driven method of procedure code selection, the employee then selects a general category of task to be performed typically from a Task Category general menu (not shown). General task categories may include but not be limited to Administration, Repair, Parts, Diagnose, etc.

Once a Task Category is selected, a check may optionally be made to determine that the employee is authorized to access the particular Task Category. For example, a work technician may not be allowed to access the Administration Task Category.

Assuming that the employee is authorized to access a particular Task Category, a first level sub-menu of options is displayed, and the employee selects a sub-task typically from the first level sub-menu.

Such menu-drive approaches to selecting a task are believed to be well known to those of skill in the art. Consequently, such system are neither further described nor discussed herein.

For example, if a repair is to be made, the first level sub-menu might list engine, drive train, suspension, brakes, cooling, electrical, body, and accessory. If the employee selects, for example suspension, the lower level sub-menu may include front suspension, rear suspension, both. Assuming that the employee might select front suspension, the next sub-menu might include the choices front right, front left, both front right and left. Assuming the employee selects front right, the next lower level sub-menu might include shock absorber, strut, stabilizer, and any other suspension specific components included on the identified vehicle. This hypothetical example is chosen for purposes of illustration of the use of sub-menus. It will be noted that those of skill in the art that actually categories of information on menus and/or sub-menus may be greatly different and me vary from one vehicle repair facility to another depending upon the specialization of the repair facility.

The badging database, not specifically identified, resides in storage device 1204. Each time a badging operation 1400 is performed, a new record is placed into the badging database.

One of many possible typical data structures for records in the badging database might be:
Job ID: (assigned by system)
Vehicle ID: (Typically the VIN)
Start Date/Time: Date yyyymmddhhmmss (24 hour format)
Employee ID:
Employee Authorization: (controls Task Category access)
Employee Job Skill Code:
Task ID: (specific code for vehicle sub-system/component)
Memo: Free-form memo field for diagnostic and repair notes

Each of the processes 100-1000 of FIG. 1 previously discussed are revisited and modifications required to implement a computerized embodiment are discussed. Each of FIGS. 2-11 are replicated in FIGS. 15-24, respectively. Certain steps previously discussed in each of FIGS. 2-11 are expanded to add the unique computer tracking processes of the invention.

It will be recognized that in some implementations of the novel VMVR system, some implementors will require some steps to be “badged” and not others while other implementors will select other steps and/or procedures to be “badged”. Consequently, the invention is not considered limited to specific steps or procedures disclosed as being “badged”. Rather, the invention is intended to include any combination of “badged” steps and/or procedures substituted or added to those steps and/or procedures chosen for purposes of disclosure.

Referring now also to FIG. 15, there is shown a modified, simplified flow chart of the interview Customer process, generally at reference number 102′.

It is expected that software implementing the unique check verification of the VMVR system of the invention is integrated into one of several vehicle repair facility management software packages. One exemplary software package known to and used by the present inventor is the NAPATRACS® software from Genuine Parts Company of Atlanta, Ga. Other such packages are believed to be well known to those of skill in the art and, consequently, are not further described or discussed herein. It will be recognized that the software of the present invention is not intended for exclusive compatibility with NAPATRACS®. Rather, the novel software of the invention is intended (with suitable interface modifications when necessary) to be compatible with any other similar software packages in addition to the NAPATRACS® software chosen for purposes of disclosure.

As shown at block 105, the employee (e.g., a customer intake technician), “badges” and uses an operation code for “Perform Customer Intake.” Consequently, block 105 is marked with an “*” (i.e., an asterisk) to designate that the process disclosed at block 105 is a “badging” operation.

Note: all “badging” operations are done in pairs—a “badging at the start of the operation and then a “badging” operation at the conclusion of the operation. This creates a pair of data records for the operation and elapsed time may be calculated. Consequently, at block 114, a second “badging” operation is performed.

In the embodiment chosen for purposes of disclosure, “badging” operations are indicated at blocks 118, 120, 122, 126, 1nd 129.

It is believed that NAPATRACS® includes necessary features to perform the steps of blocks 118 and 120. However, necessary software may readily be written to handle the customer data intake or update functions as required. That software would form no part of the present invention.

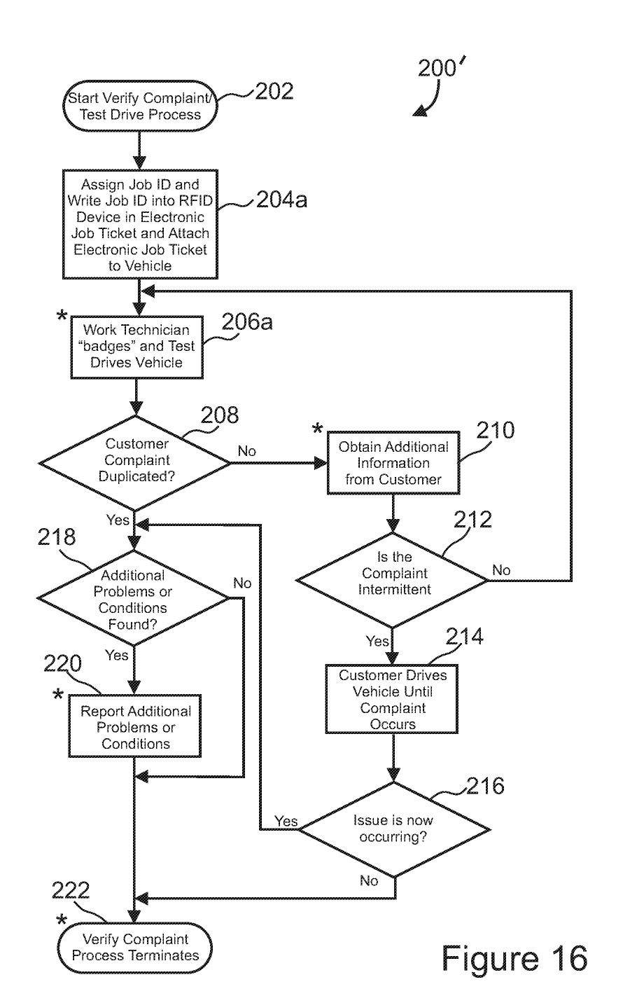

Referring now also to FIG. 16, there is shown a modified, simplified flow chart of the Verify Complaint/Test Drive process, generally at reference number 200′.

In FIG. 3, block 204, a Job ID for the vehicle repair is generated and a Job Ticket is generated.

In FIG. 16, original block 204 is replaced by block 204a that shows the step: “Assign Job ID, Write Job ID to RFID Device in Electronic Job Ticket and Attach Electronic Job Ticket to Vehicle.”

Likewise, in FIG. 3, block 206 recites the step: “Test Drive Vehicle.” However, FIG. 16 block 206a, recites the step: “Technician “badges” and Test Drives Vehicle”

Additionally, blocks 210, 220 and 222 are designated as steps or processes that require “badging” operation.

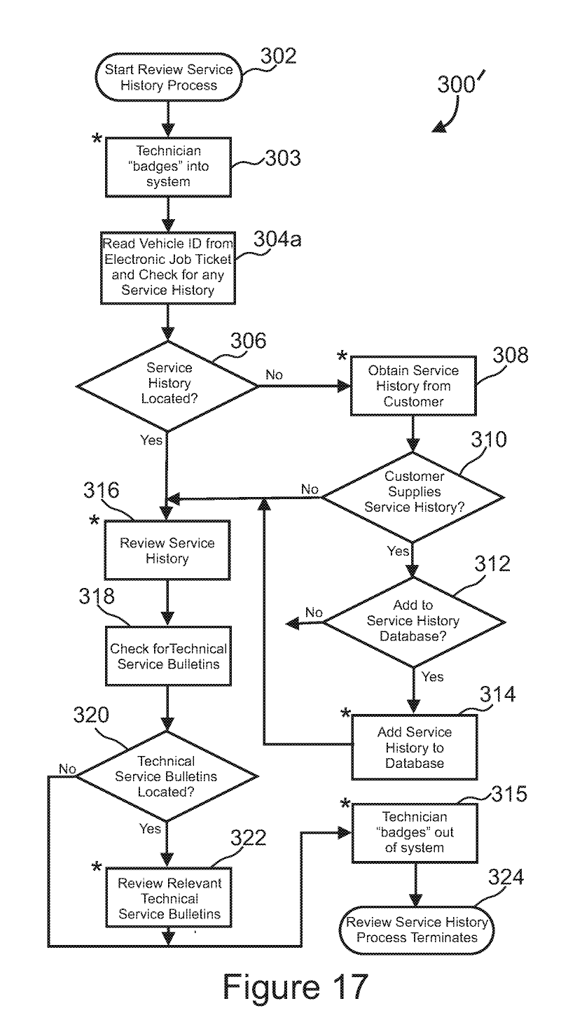

Referring now also to FIG. 17, there is shown a modified, simplified flow chart of the Review Service History process, generally at reference number 300′.

In block 304 as shown in FIG. 5, the Vehicle ID is entered and a check is made for any service history.

In FIG. 17 block 304 is replaced by block 304a that recites the step: “Read Vehicle ID from Electronic Job Ticket and check for any service history.”

Blocks 303, 308, 314, 315, 316, 322 and 324 are also designated as requiring a “badging” operation. It should be noted that in some embodiments a single operation code may include two or more of the individual steps designated as requiring a “badging” operation. When steps are combined, only a single “badging” operation may be required rather than the multiple “badging” operations shown in FIG. 17.

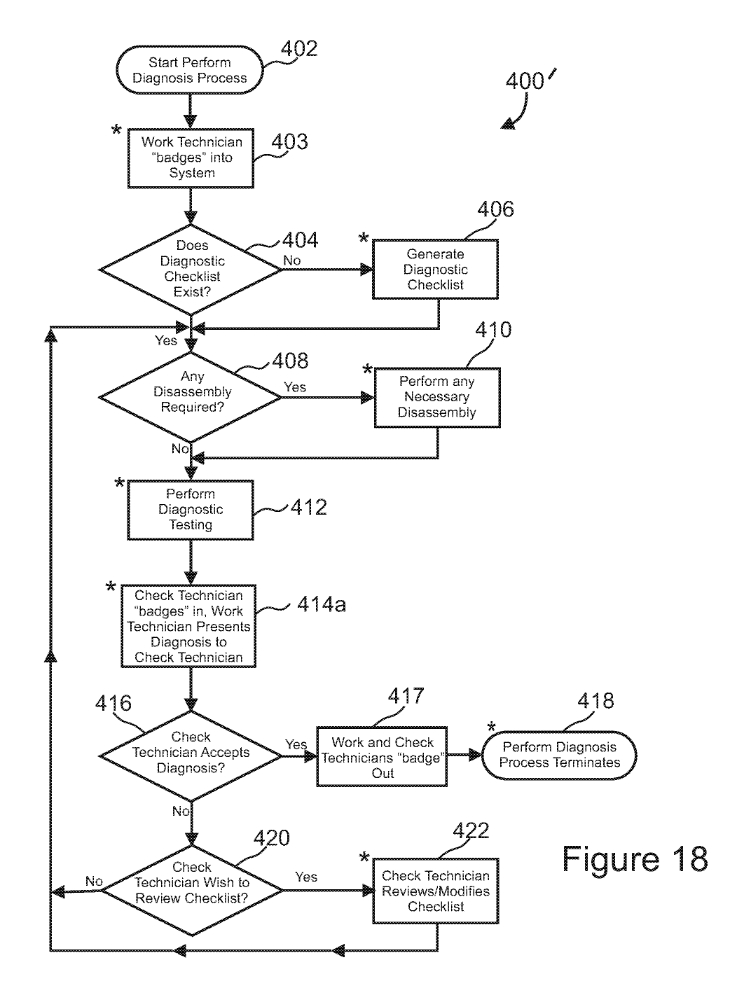

Referring now also to FIG. 18, there is shown a modified, simplified flow chart of the Perform Diagnosis process, generally at reference number 400′.

The steps of Perform Diagnosis process 400′ relies on login of both a work technician and a check technician.

A new block 403 has been added that recites: “Work Technician “badges” into System.”

In FIG. 5, block 414 recites: “Present Tentative Diagnosis to Check Technician”. However, in FIG. 18 block 414 is replaced by block 414a that recites: “Check Technician “badges” in, Work Technician Presents Diagnosis to Check Technician.”

Other blocks in FIG. 18 where “badging” is now required include blocks 406, 410, 412, 418 and 422.

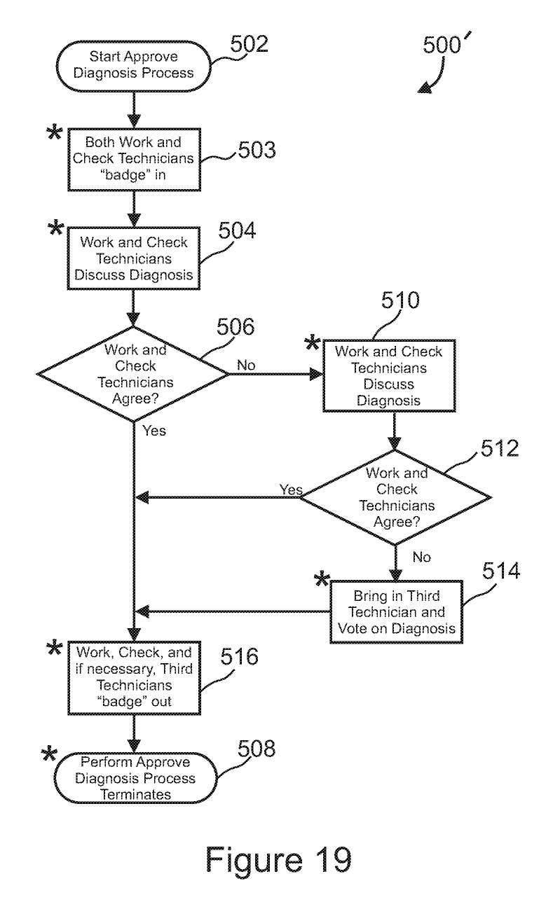

Referring now also to FIG. 19, there is shown a modified, simplified flow chart of the Start Diagnosis process, generally at reference number 500′.

In FIG. 19 blocks 503, 504, 510, 514, 516 and 508 are designated as reciting operations that require a “badging” operation.

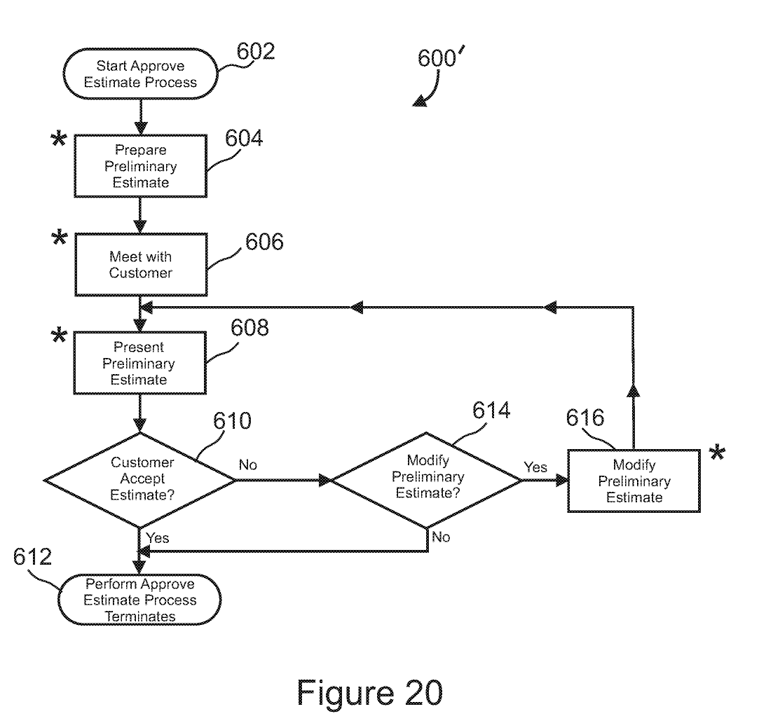

Referring now also to FIG. 20, there is shown a modified, simplified flow chart of the Approve Estimate process, generally at reference number 600′.

In FIG. 20, blocks 604, 606, 608, 616 and 612 are designated as reciting operations that require a “badging” operation. However, again it should be noted that several of the operations may be combined into a single operation expected to be performed by a single individual and, therefore, some of the indicated “badging” operations may possibly be eliminated.

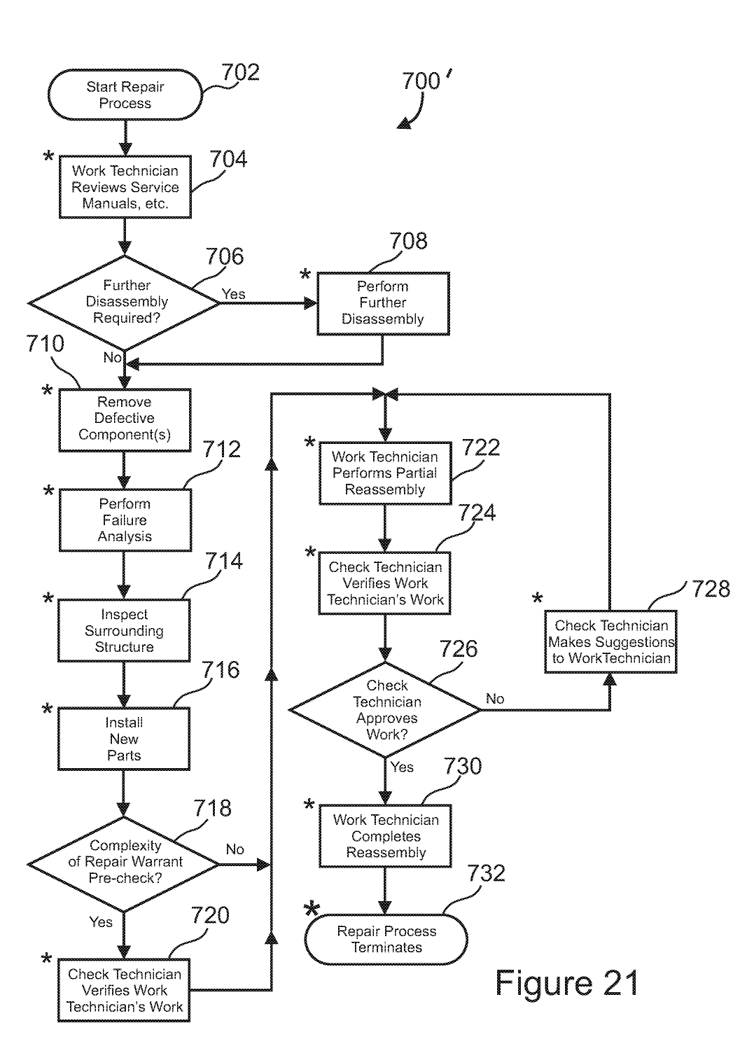

Referring now also to FIG. 21, there is shown a modified, simplified flow chart of the Perform Repair process 700′.

In FIG. 21, blocks 704, 708, 710, 712, 714, 716, 720, 722, 724, 728, 730 and 732 are designated as reciting operations that require a “badging” operation. However, again it should be noted that two or more of the operations may be combined into a single operation expected to be performed by a single individual and, therefore, some of the indicated “badging” operations may possibly be eliminated.

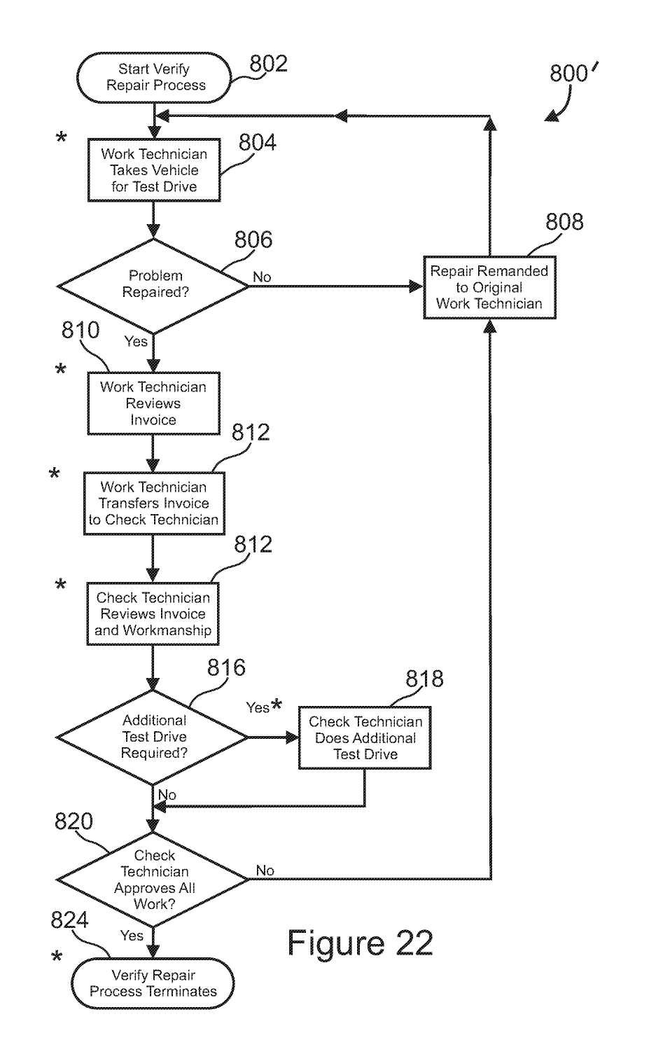

Referring now also to FIG. 22, there is shown a modified, simplified flow chart of the Perform Repair process 800′.

In FIG. 22, blocks 804, 810, 812, 818, and 824 are designated as reciting operations that require a “badging” operation. However, again it should be noted that two or more of the operations may be combined into a single operation expected to be performed by a single individual and, therefore, some of the indicated “badging” operations may possibly be eliminated.

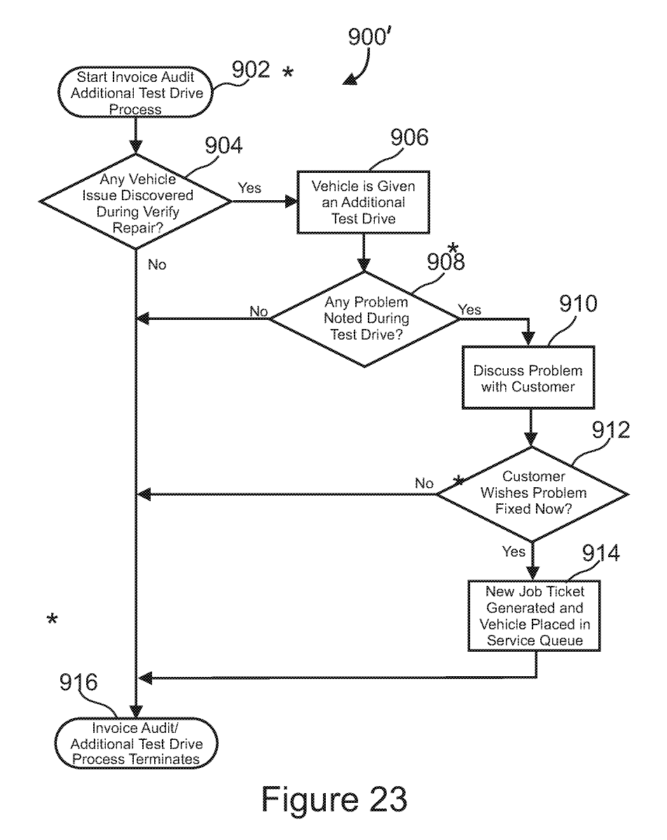

Referring now also to FIG. 23, there is shown a simplified flow chart of the Invoice, Audit and Additional Test Drive process 900′.

In FIG. 23, blocks 906, 910, 914 and 916 are designated as reciting operations that require a “badging” operation.

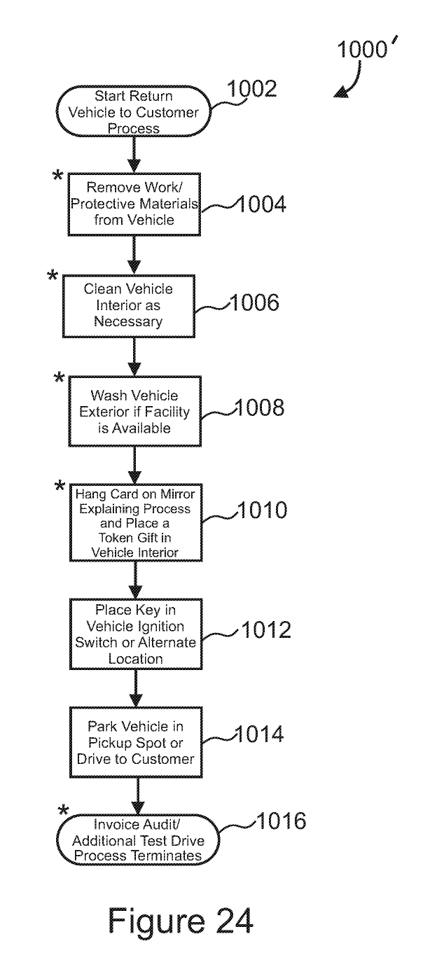

Referring now also to FIG. 24, there is shown a modified, simplified flow chart of the Return Vehicle to Customer process 1000′.

In FIG. 24, blocks 1004, 1006, 1008, 1010 and 1016 are designated as reciting operations that require a “badging” operation. It is considered likely that at least two of the operations recited in blocks 1004, 1006, 1008 and 1010 may be performed by the same person, thereby allowing reducing the number of “badging” operation required.

As stated above, each badging operation generates a badging record in the badging database.

It will be recognized by those of skill in the art that conventional database querying techniques may be used to analysis data in the badging database and a series of management reports may readily be generated therefrom.

Several report generating software packages well known to those of skill in the art may be used to create custom reports suitable for a particular motor vehicle repair businesses. The databases provides by the novel system of the invention lend themselves for querying by such software packages.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A verified motor vehicle repair process, the steps comprising:
a) interviewing a customer associated with a motor vehicle regarding a problem associated with said motor vehicle;
b) verifying said problem associated with said motor vehicle;
c) diagnosing of said problem and generating a diagnosis thereof;
d) using at least one other person to verify said diagnosis;
e) performing a repair of said problem based on said diagnosis; and
f) using at least one other person to verify said repair has corrected said problem.

2. The verified motor vehicle repair process as recited in claim 1, wherein said diagnosing step (c) further comprises the sub-step:
g) if extant, reviewing a service history associated with said vehicle.

3. The verified motor vehicle repair process as recited in claim 1, wherein said performing a repair step (e) comprises the sub-step:
i) prior to performing the repair, generating an estimate for the repair based on said diagnosis and obtaining approval of said estimate from said customer.

4. The verified motor vehicle repair process as recited in claim 1, the steps further comprising:
g) test driving said vehicle.

5. The verified motor vehicle repair process as recited in claim 1, wherein said verifying said problem step (b) comprises test driving said motor vehicle.

6. The verified motor vehicle repair process as recited in claim 1, wherein said at least one of said verifying step (b), said diagnosing step (c), and performing a repair step (e) is performed by a work technician.

7. The verified motor vehicle repair process as recited in claim 6, wherein said using at least one other person to verify said diagnosis step (d), and said using at least one other person to verify said repair has corrected said problem step (g) is performed by a check technician.

8. The verified motor vehicle repair process as recited in claim 7, wherein said using at least one other person to verify said diagnosis step (d) comprises agreement between said work technician and said check technician.

9. The verified motor vehicle repair process as recited in claim 8, wherein when agreement between said work technician and said check technician is not reached, consulting a third person and voting on competing diagnoses.

10. The verified motor vehicle repair process as recited in claim 1, wherein said performing a repair of said problem based on said diagnosis step (e) comprises removing at least one selected from the group: a part, a component, and a sub-system from said motor vehicle and replacing said removed at least one selected from the group: a part, a component, and a sub-system with an equivalent one selected from the group: a part, a component, and a sub-system.

11. The verified motor vehicle repair process as recited in claim 10, wherein said performing a repair of said problem based on said diagnosis step (e), further comprising the sub-step:
g) verifying said at least one selected from the group: a part, a component, and a sub-system removed from said motor vehicle is defective.

12. A verified motor vehicle repair process, the steps comprising:
a) providing a data processing apparatus comprising at least one reader for reading data from a machine readable device, hereinafter a “badge”, memory for storing information read from said badge, and a processor for comparing at least data resulting from reading at least two badges;
b) providing at least two technicians, each of said at least two technicians having a badge, each of said badges carrying unique information related to a respective one of said at least two technicians;
c) receiving a motor vehicle for repair, said motor vehicle experiencing a problem, and creating a badge carrying a unique identification associated with said motor vehicle and physically associating said badge with said motor vehicle;
d) verifying said problem associated with said motor vehicle by at least one of said at least two technicians, said at least one technicians performing at least one badge reading operation associated with said verifying operation;
e) diagnosing said problem and generating a diagnosis thereof by at least one of said at least two technicians, said at least one technicians performing at least one badge reading operation associated with said diagnosing operation;
f) using at least one different one of said at least two technicians to verify said diagnosis, said different one of said at least two technicians performing at least one badge reading operation associated with said verifying said diagnosis operation;
g) performing a repair of said problem based on said diagnosis by at least one of said at least two technicians, said at least one of said at least two technicians performing at least one badge reading operation associated with said performing a repair operation; and
h) using at least one of said at least two technicians other than said at least one of said at least two technicians used to perform repairing step (g) to verify that said repair has corrected said diagnosed problem, said at least one technician other than said at least one of said at least two technicians used to perform repairing step (g) performing at least one badge reading operation associated with said diagnosing operation.

13. The verified motor vehicle repair process as recited in claim 12, wherein said badge comprises an RFID device.

14. The verified motor vehicle repair process as recited in claim 12, wherein said receiving a motor vehicle step (c) further comprises the sub-step:
i) interviewing a customer associated with said motor vehicle regarding said problem.

15. The verified motor vehicle repair process as recited in claim 12, wherein said diagnosing step (e) further comprises the sub-step;
i) if extant, reviewing a service history associated with said motor vehicle by at least one of said at least two technicians, said at least one technician performing at least one badge reading operation associated with said reviewing a service history operation.

16. The verified motor vehicle repair process as recited in claim 12, wherein prior to performing said performing a repair step (g), using at least one of said at least two technicians, generating an estimate based on said diagnosis and obtaining approval of said customer of said estimate, said at least one technician performing at least one badge reading operation associated with said generating an estimate operation.

17. The verified motor vehicle repair process as recited in claim 12, the steps further comprising:
i) using at least one of said at least two technicians, taking an additional test drive of said vehicle, said one of said at least two technicians, performing at least one badge reading operation associated with said taking an additional test drive of said vehicle operation.

18. The verified motor vehicle repair process as recited in claim 12, wherein said verifying said problem step (d) comprises at least one of said at least two technicians taking a test drive, one of said at least two technicians performing at least one badge reading operation associated with said taking a test drive.

19. The verified motor vehicle repair process as recited in claim 12, wherein said at least of said at least two technicians performing at least steps: verifying said problem step (d), said diagnosing said problem step (e), and performing a repair step (g) is designated a work technician.

20. The verified motor vehicle repair process as recited in claim 12, wherein said at least one of said at least two technicians performing step: d) using at least one different one of said at least two technicians to verify said diagnosis, and step h) using at least one of said at least two technicians other than said at least one of said at least two technicians used to perform repairing step (g) to verify that said repair has corrected said diagnosed problem is designated a check technician.

21. The verified motor vehicle repair process as recited in claim 20, wherein said using at least one other person to verify said diagnosis step (d) comprises obtaining agreement between said work technician and said check technician.

22. The verified motor vehicle repair process as recited in claim 21, wherein when agreement between said work technician and said check technician is not reached, consulting a third person and voting on competing diagnoses.

23. The verified motor vehicle repair process as recited in claim 12, wherein said performing a repair of said problem based on said diagnosis step (g) comprises at least one technician selected from the group at least two technician removing at least one selected from the group: a part, a component, and a sub-system from said motor vehicle and replacing said removed at least one selected from the group: a part, a component, and a sub-system with an equivalent one selected from the group: a part, a component, and a sub-system, said at least one technician selected from the group at least two technicians performing a badge reading associated with said removing and replacing step.

24. The verified motor vehicle repair process as recited in claim 23, wherein said performing a repair of said problem based on said diagnosis step (g), further comprising the sub-step:
i) using at least one of said at least two technicians to verify that said at least one selected from the group: a part, a component, and a sub-system removed from said motor vehicle is defective, said at least one technician performing a badge reading associate with said verifying step.

25. The verified motor vehicle repair process as recited in claim 12, wherein said using at least one other person to verify said repair has corrected said problem step (h) comprises the sub-step: using at least one check technician selected from said at least two technicians to verify that said performing a repair step (g) has been correctly performed, said at least one check technician performing at least one bad reading operation associated with said verifying said repair step (h).

26. The verified motor vehicle repair process as recited in claim 12, wherein said step: using at least one other person to verify that said performing a repair step (h) has been correctly performed is performed by at least one check technician selected from said at least two technicians, said at least one check technician performing at least one badging operation associated with said verifying that said performing a repair step (h) has been correctly performed.
